(19) United States
(12) Patent Application Publication
(10) Pub. No.: US 2020/0368680 A1
(43) Pub. Date: Nov. 26, 2020

(54) Method for Treating Exhaust Gases Containing Sulfur Oxides

(71) Applicant: DrySoTec GmbH, Essen (DE)

(72) Inventors: Bernd MORUN, Essen (DE); Paul-Udo SCHMIDT, Essen (DE)

(73) Assignee: DrySoTec GmbH, Essen (DE)

(21) Appl. No.: 16/956,059

(22) PCT Filed: Nov. 21, 2018
(86) PCT No.: PCT/EP2018/082015

§ 371 Date: Jun. 19, 2020

(30) Foreign Application Priority Data
Dec. 20, 2017 (DE) 10 2017 011 799.3
Mar. 14, 2018 (DE) 10 2018 105 892.6

(51) Int. Cl. B01D 53/50; B01D 53/10; B01D 53/75; B01D 53/83; B01D 53/26; B01D 46/00

(52) U.S. Cl. CPC B01D 53/508; B01D 2259/128; B01D 53/75; B01D 53/83; B01D 53/265; B01D 46/0027; B01D 2251/404; B01D 2251/604; B01D 2253/112; B01D 2253/304; B01D 2253/306; B01D 2253/311; B01D 2257/302; B01D 2259/122; B01D 53/10

(57) ABSTRACT

The invention relates to the technical field of the treatment of exhaust gases containing sulfur oxides, especially exhaust gases from technical combustion plants, the so-called flue gases, or exhaust gases from technical processes, such as steel production (e.g. blast furnace gases, etc.) Especially, the invention relates to a method for the treatment of exhaust gases containing sulfur oxides, in particular from technical combustion plants, such as flue gases, or from technical processes, for the purpose of removing and/or separating off the sulfur oxides or for the purpose of reducing the sulfur oxide content, as well as a system for carrying out the method.

### CROSS-REFERENCES TO RELATED APPLICATIONS

This application is a National Stage filing of International Application PCT/EP 2018/082015 filed Nov. 21, 2018, entitled “Method for Treating Exhaust Gases Containing Sulfur Oxides”, claiming priority to DE 10 2017 011 799.3, filed Dec. 20, 2017, and DE 10 1018 105 892.6 filed Mar. 14, 2018. The subject application claims priority to PCT/EP 2018/082015, DE 10 2017 011 799.3, and DE 10 1018 105 892.6 and incorporates all by reference herein, in their entirety.

### BACKGROUND OF THE INVENTION

The present invention relates to the technical field of the treatment of exhaust gases containing sulfur oxides (SOx), in particular exhaust gases from technical combustion plants, the so-called flue gases, or exhaust gases from technical processes, such as steel production (e.g. blast furnace gases etc.).

In particular, the present invention relates to a method for treating sulfur oxides-containing exhaust gases, in particular from technical combustion plants, such as flue gases, or from technical processes, for the purposes of removing and/or separating off the sulfur oxides or for the purposes of reducing the sulfur oxide content, as well as a system (installation, plant) for carrying out the method.

Flue gases are generally understood to be exhaust gases from stationary, large-scale incineration plants, such as gas and coal-fired power plants or waste incineration plants. These exhaust gases contain substances that are hazardous to the environment and health and must therefore be cleaned—not least to comply with legal requirements.

Gaseous or highly volatile substances with a not insignificant hazard potential for humans and the environment, which are usually produced during combustion processes, are mainly oxides of carbon, nitrogen and sulfur as well as hydrogen chloride. The carbon oxides are carbon dioxide, known as greenhouse gas, and the highly toxic carbon monoxide, which is approximately as toxic as hydrocyanic acid. The nitrogen oxides, sulfur oxides and hydrogen chloride are also partly toxic and all form acids on contact with water, which leads, as so-called acid rain, to acidification of the soil. In addition, the nitrogen oxides are converted into nitrates in the atmosphere and thus lead to over-fertilization or eutrophication of water bodies. Further components of the flue gases are fine dust, soot and fly ash, which can be carcinogenic and contaminated with heavy metals and play a role in the formation of smog. Furthermore, combustion processes often produce organic compounds, such as highly toxic dioxins or VOCs (Volatile Organic Compounds), which are responsible for the formation of ground-level ozone.

Methods are known in the prior art with which the aforementioned substances, with the exception of carbon dioxide, can be removed from the exhaust gases or with which their amount is significantly reduced.

For example, the amount of carbon monoxide in the exhaust gases is kept low by means of targeted combustion control. Furthermore, carbon monoxide produced can be returned to the combustion chamber or converted to carbon dioxide in a subsequent burner stage.

Similarly, the amount of nitrogen oxides in the exhaust gases is kept low by specifically controlling the conditions under which combustion takes place. Alternatively, however, the nitrogen oxides can also be reduced to elemental nitrogen with nitrogen oxide-containing compounds, such as ammonia or urea, by spraying or injecting the nitrogen-containing substances into the combustion chamber at around 900° C. or by a downstream catalytically activated reaction.

Fine dust, soot and fly ash can be separated from the exhaust gases by a filter system such as bag filters or electrostatic precipitators, while volatile organic compounds (VOCs) can be removed by adsorption on activated carbon or by condensation.

For the separation of sulfur oxides from the exhaust gases, a large number of methods are known in the prior art. In principle, a distinction is made between regenerative and non-regenerative methods. A regenerative method for exhaust gas desulfurization is, for example, the Wellmann-Lord method, which converts the sulfur dioxide from the exhaust gas with a sodium sulfite solution to form sodium hydrogen sulfite. By later heating the sodium hydrogen sulfite, sulfur dioxide is released again and the sodium sulfite can then be used to absorb sulfur dioxide again. Overall, however, the importance of regenerative methods is extremely low compared to non-regenerative methods. The non-regenerative methods all aim at binding sulfur oxides as sulfates by chemical conversion. This takes place in lime washing in the form of gypsum (CaSO₄-2H₂O), in dry sorption in the form of sodium sulfate and in the ammonia REA method (Walther method) in the form of ammonium sulfate.

The state-of-the-art methods for the separation or removal of sulfur oxides from exhaust gases all have serious disadvantages. Dry sorption, in the course of which the sulfur oxides are reacted with sodium hydrogen carbonate and/or hydrated lime, for example, is highly effective, but cannot be carried out cost-effectively due to the relatively cost-intensive sodium hydrogen carbonate. These costs make the method in which the sulfur-containing exhaust gases are produced more expensive, and thus ultimately also the manufactured products.

For desulfurization it is known to use a so-called wet scrubber, i.e. a solution or dispersion of hydrated lime (Ca(OH)₂) is sprayed into the exhaust gas stream, which not only chemically binds the sulfur oxides, especially sulfur dioxide, but also removes the majority of the air-borne dust from the exhaust gases at the same time. However, this exhaust gas treatment has the disadvantage that, especially during lime washing with calcium hydroxide solution, enormous quantities of poorly soluble residues contaminated with heavy metals are produced. It is not readily possible to separate the residues from the heavy metals again, so that the entire residue has to be disposed of as hazardous waste, resulting in enormous costs. Furthermore, large amounts of waste water are produced, which also have to be laboriously cleaned.

The ammonia FGD method is not of great technical importance, as it combines the disadvantages of the above-mentioned methods. However, the ammonium sulfate obtained can be used as fertilizer.

Exhaust gases from technical processes such as steel production (e.g. exhaust gases from chemical roasting or sinter belt production, blast furnace gases from the blast furnace process, etc.) may also contain significant amounts of sulfur oxides. Until now, however, no efficient methods for separating the sulfur oxides from the relevant exhaust gases from these technical processes are known.

Nevertheless, it is known in the prior art that in the dry sorption method the separation efficiency can be improved under certain conditions when separating pollutants with hydrated lime, according to which the economic efficiency of the dry sorption method can also be increased. These include, above all, an increase in the relative exhaust gas humidity or an increase in the water vapor content of the exhaust gases. This can increase the efficiency of the dry sorption method. The influence of exhaust gas humidity is particularly noticeable in the separation of sulfur dioxide. This can be achieved, for example, by adding or feeding milk of lime—a suspension of hydrated lime in water—to the exhaust gas.

Furthermore, it is known to add an exhaust gas treatment reagent to the exhaust gas, which for example contains lime. The exhaust gas is cooled down by the upstream or simultaneous evaporation of water. Thus the water content or the water vapor content of the flue gas or the exhaust gases can be increased due to the evaporated water. Both factors ultimately lead to an increase in the relative humidity and/or water vapor content of the exhaust gases, thus enabling more effective separation of pollutants in the exhaust gases.

The disadvantage here is that if the exhaust gas is cooled down to its dew temperature, condensation occurs. The condensates can cause corrosion damage in the exhaust gas duct, so that a sufficient temperature difference from the dew point of the exhaust gases should be maintained. Although the increased humidity of the exhaust gas improves the separation of pollutants, the risk of corrosion of the plant components in the entire exhaust gas path also increases, and accordingly the investment costs and the technical expenditure also increase.

A particular disadvantage of the addition of water and/or steam in the exhaust gas duct is that the subsequently added exhaust gas treatment reagent causes caking or agglomerations on plant components. The resulting caking or agglomeration can cause damage, so that water and/or steam can only be added to the exhaust gas within a short time frame or period of time in relation to the actual service life of a dry sorption system. The caking or agglomerations prevent that, despite increasing pollutant separation and increased efficiency of the dry sorption process, an increase in the moisture in the flue gas duct is usually not technically implemented The investment costs and the operating downtimes caused, for example, by a caked nozzle exceed the temporary reduction in operating costs due to the savings of the exhaust gas treatment reagent due to the improved efficiency.

The laws on the emission of pollutants have been consistently tightened in recent years and even stricter regulations are expected in the future, so that there is a great need for efficient and economically as well as ecologically sensible treatment of exhaust gases.

### BRIEF SUMMARY OF THE INVENTION

The present invention is now based on the object of providing a method for the desulfurization of exhaust gases or other sulfur oxide-containing flue gases or a method for the treatment of exhaust gases containing sulfur oxides, in particular exhaust gases from technical combustion plants or exhaust gases from technical processes (such as steel production), for the purposes of removing and/or separating off the sulfur oxides or for the purposes of reducing the sulfur oxide content, which at least essentially overcomes or at least partially avoids the disadvantages of the methods of the prior art described hereinabove.

Furthermore, the invention is based in particular on the object of providing such an exhaust gas treatment method which, in the case of dry sorption, has a high efficiency and/or a high separation efficiency of the sulfur oxides, but prevents or at least significantly reduces caking or agglomerations on plant components.

In particular, such a method for the treatment of exhaust gases containing sulfur oxides from technical processes for the purpose of removal and/or separating off the sulfur oxides and/or for the purpose of reducing the technical sulfur oxide content shall result in improved environmental compatibility and/or improved process economy, but shall nevertheless reliably ensure that efficient exhaust gas treatment and/or desulfurization of the exhaust gases to be treated takes place.

In particular, it is the task of the present invention to provide such an efficient and advantageous method for the exhaust gas treatment of exhaust gases, which includes a safe and trouble-free operation of the entire plant for carrying out the technical method.

For the solution of the task described above, the present invention proposes—in accordance with a first aspect of the present invention—a method for the treatment of sulfur oxides (SOx)-containing exhaust gases from technical processes for the purposes of removing and/or separating off the sulfur oxides and/or for the purposes of reducing the sulfur oxide content (exhaust gas treatment method); further and/or especially advantageous embodiments of the inventive method are the subject-matter of the exhaust gas treatment method.

Furthermore, the present invention relates—according to a second aspects of the present invention—to a system (installation, plant) for the treatment of sulfur oxides (SOx)-containing exhaust gases from technical processes in accordance with the independent system described in this respect; further and/or especially advantageous embodiments of the inventive system are the subject-matter of the further disclosure.

Finally, the present invention—according to a third aspect of the present invention—refers to the use(s) of the inventive system and/or of the inventive method.

It goes without saying in the following explanations that features, embodiments, advantages and the like, which in the following are only explained for one aspect of the invention for the purpose of avoiding repetitions, do, of course, also apply correspondingly in relation to all other aspects of the present, without this having to be mentioned separately.

In relation to all relative or percentage weight-related indications mentioned hereinbelow, in particular relative quantity or weight details, it should further be noted that within the scope of the present invention, it goes without saying that these indications are, in the context of the present invention, to be selected and/or to be combined by a person skilled in the art such that the resulting sum—including all further components/ingredients—always results in 100% or 100 wt-%, respectively.

Furthermore, the skilled person—depending on the application or individual case—may, if necessary, deviate from the specified ranges listed below without leaving the scope of the present invention.

In addition, all values or parameters or the like specified in the hereinbelow can generally be determined using standardized or explicit methods of determination or otherwise with methods of determination or measurement that are generally used by experts in this field.

Having stated this, the present invention will be described in more detail hereinafter.

### BRIEF DESCRIPTION OF THE DRAWINGS

FIG. 1 provides a schematic representation of an inventive system according to a particular embodiment of the present invention;

FIG. 2 provides a schematic representation of an exhaust gas treatment device according to a special embodiment of the present invention;

FIG. 3 provides a schematic representation of an inventive system in accordance with a particular embodiment of the present invention;

FIG. 4 provides a schematic method sequence of the individual stages or method steps of the method according to the invention for the treatment of sulfur oxides (SOₓ)-containing exhaust gases according to a special embodiment of the present invention and

FIG. 5 provides a schematic method sequence of the individual stages or method steps of the method according to the invention for the treatment of sulfur oxides (SOₓ)-containing exhaust gases according to a special embodiment of the present invention.

### DETAILED DESCRIPTION OF THE INVENTION

The subject of the present invention—according to an first aspect of the present invention—is thus a method for the treatment of sulfur oxides (SOx)-containing exhaust gases from technical processes for the purpose of removing and/or separating off the sulfur oxides and/or for the purpose of reducing the sulfur oxide content,

wherein the sulfur oxides-containing exhaust gases are subjected to an exhaust gas treatment, especially desulfurization, by means of at least one particulate sulfur oxide-reactive exhaust gas treatment reagent, especially desulfurization reagent,

wherein in the method
(a) first, the sulfur oxides-containing exhaust gases are brought into contact with the exhaust gas treatment reagent and/or treated such that an exhaust gas stream containing the exhaust gas treatment reagent is obtained (“method step (a)”), and
(b) subsequently, the exhaust gas stream containing the exhaust gas treatment reagent is brought into contact with and/or treated with water vapor, especially such that the exhaust gas treatment reagent is reacted with the sulfur oxides contained in the exhaust gases (“method step (b)”).

The fact that the exhaust gas treatment reagent is reacted with the sulfur oxides contained in the exhaust gases shall be understood in particular as meaning that it is not necessary and/or mandatory to convert all exhaust gas treatment reagent. Similarly, it is not necessarily or imperatively provided that all sulfur oxides are converted. Consequently, there may be an excess of exhaust gas treatment reagent, so that only a certain proportion of the exhaust gas treatment reagent is reacted with the sulfur oxides contained in the exhaust gases. Furthermore, not all of the sulfur oxides contained in the exhaust gases need to react with the exhaust gas treatment reagent. Preferably, a conversion of the sulfur oxides is configured such that the legal requirements or regulations for cleaning the exhaust gas are complied with or, if possible, even fall below.

“Sulfur oxides” (general formula SₓO_{y}) according to the invention are oxides of the chemical element sulfur. In this context, sulfur oxides include any possible sulfur oxide compound, especially sulfur dioxide (SO₂) and sulfur trioxide (SO₃). In addition, the correlating acids of the sulfur oxides are also to be understood under the general term “sulfur oxides”, so that the correlating acids formed in aqueous solutions are also regarded as sulfur oxides within the meaning of the present invention.

Analogous to the previously outlined conversion of sulfur oxides by means of the exhaust gas treatment reagent, the purpose of the method is also:
for the purposes of removing and/or separating off sulfur oxides and/or reducing the sulfur oxide content

such that not all sulfur oxides are necessarily removed. Especially, as many sulfur oxides are removed or separated off as can be achieved and/or is required in terms of process engineering on the basis of the method according to the invention. The procedural specification of the minimum degree of separation of the sulfur oxides may, for example, be subject to legal and/or technical specifications, such as plant conditions, or may be influenced by the aforementioned factors.

For the purposes of the present invention, “sulfur oxide-reactive” means that a reagent—in this case the exhaust gas treatment reagent—can react with sulfur oxides in a chemical and/or physical manner. Preferably the reagent reacts with the sulfur oxides in a chemical reaction so that the sulfur oxides are reacted. A reaction of the sulfur oxides can take place, for example, by means of reduction, hydrolysis and decomposition or the like.

As explained below, the present invention is associated with a multitude of completely unexpected advantages, peculiarities and surprising technical effects. The following description does not claim to be complete, but illustrates the inventive character of the present invention:

Surprisingly, the present invention makes it possible to provide an exhaust gas treatment method which, with a significantly improved efficiency compared to the prior art, involves the separation or reduction of sulfur oxides from the exhaust gases.

It was surprising and in no way predictable for the skilled practitioner that a subsequent introduction and/or addition of water vapor into the exhaust gas stream would lead to a significantly improved process economy and in particular to a reduction in the consumption of exhaust gas treatment reagent. In the prior art, the subsequent introduction of water vapor has even been avoided in order to avoid caking or agglomerations on the lance introducing the water vapor.

On the contrary, the present invention results in almost no caking or agglomerations on the plant components, in particular on the injection and/or spraying device for the steam. In addition, it could be shown in comparison to the prior art that caking or agglomerations on the plant components can be significantly reduced, while at the same time the already known effect of efficiency improvement due to the increase in relative humidity of the exhaust gas or due to the increase in water vapor content of the exhaust gases can be used according to the invention.

Advantageously, a significantly increased separation efficiency, especially of the sulfur oxides, is ensured by the method for exhaust gas treatment according to the present invention. As already known in the prior art, the effectiveness of the pollutant separation can be increased by generating a liquid phase (hydrate shell) on the surfaces of the particulate exhaust gas treatment reagents, wherein the hydrate shell drastically and significantly favors the conversion of the sulfur oxide and increases the kinetics of the chemisorptive reaction due to the aqueous region compared to dry particles. Thus, the particulate, dry exhaust gas treatment reagent in method step (a) reacts in a significantly lower ratio compared to the reaction in method step (b) and/or exhibits a significantly lower separation efficiency of the sulfur oxides. By increasing the moisture and/or water vapor content of the exhaust gases, in method step (b) it can be ensured that the required proportion of sulfur oxides can be removed or separated from the exhaust gases and thus the sulfur oxide separation rates required, in particular by law, can be complied with.

Since the formation of the hydrate shell on the exhaust gas treatment reagent is only present for a very short time period due to the inventive supply of the water vapor, damage to the exhaust gas duct or to the plant or system components, for example due to aggressive condensates, can be avoided.

With a simplified process control and a low process engineering effort, the exhaust gas treatment method according to the invention can be used for the separation and/or reduction of sulfur oxides from exhaust gases from technical processes, whereby the economic efficiency of the exhaust gas treatment method can be ensured while guaranteeing a long operating and/or service life of the exhaust gas treatment system (installation, plant). At the same time, the maintenance and repair costs are significantly reduced, in particular by at least 30%, also due to the avoided caking or agglomerations on the system components, and accordingly the period of use of the system according to the invention can be significantly increased, preferably by at least 50%.

Advantageously, a conversion can be carried out very easily in already existing systems (installations, plants), whereby no great technical effort is required, since ultimately the desulfurization extends to a very small area within the exhaust gas treatment chamber, especially the exhaust and/or exhaust gas duct.

In addition, there is a reduction in operating costs, as the need for exhaust gas treatment reagent is significantly reduced compared to a dry sorption method without increasing the relative humidity of the exhaust gas.

According to the invention, at least 10% of the operating costs, investment costs as well as repair and maintenance costs are reduced or saved compared to the dry sorption methods known from practice, whereby at least 20% of the amount of exhaust gas treatment reagent can be saved. In particular, the aforementioned costs are reduced by more than 60%, preferably more than 80%, more preferably between 60% and 90%, whereby an increase in efficiency of at least 5%, preferably between 10% and 50%, is achieved compared to the dry sorption methods known from the prior art.

A reduction in the consumption of the exhaust gas treatment reagent is not only relevant with regard to operating costs, but also with regard to environmental aspects, a positive effect results from the exhaust gas treatment method according to the invention. The ecological compatibility is increased due to the fact that during exhaust gas treatment the consumption of the required exhaust gas treatment reagent can be significantly reduced by increasing the water vapor content of the exhaust gas—such that caking of or agglomerations on plant components are also avoided. In the prior art, this caking or these agglomerations ultimately meant that an increase in the water vapor content of the exhaust gases could never be efficiently and permanently integrated into an exhaust gas treatment method; and that although the fundamentally positive effect of increasing the separation efficiency due to increased moisture and the associated reactions—theoretically—were fundamentally known, it was still not possible to achieve this in the past.

In the following, preferred embodiments of the inventive method for the treatment of exhaust gases or the inventive exhaust gas treatment method are described and explained in more detail:

According to a particularly preferred embodiment, the exhaust gas treatment method is a dry sorption method. In a dry sorption method, the exhaust gas treatment reagent is introduced, especially sprayed, injected and/or jetted in, in its particulate form and/or in powder form into the exhaust gas or into the sulfur oxides-containing exhaust gases. Various sulfur oxide-reactive exhaust gas treatment reagents are conceivable as exhaust gas treatment reagents in the dry sorption methods, whereby, for example, calcium hydroxide or hydrated lime (Ca(OH)₂) competes with sodium hydrogen carbonate (NaHCO₃). In the dry sorption method, it is also provided that after the exhaust gas treatment reagent has been introduced, separation is provided on a fabric filter, also known as a bag filter or tube filter. Due to a chemical reaction between the exhaust gas treatment reagent and the gaseous pollutants, especially sulfur dioxide, the pollutants are bound to the exhaust gas treatment reagent. Accordingly, this form of sorption method is also known as chemisorption. The dry sorption method according to the invention is characterized by the fact that very dry exhaust gases are subjected to exhaust gas treatment by means of the exhaust gas treatment reagent at comparatively low exhaust gas temperatures. The objective of a dry sorption method is to enable a reaction between the exhaust gas treatment reagent and the pollutants contained in the exhaust gases by introducing a preferably dry, particulate or powdery exhaust gas treatment reagent and then to separate the pollutants bound to the exhaust gas treatment reagent in a fabric filter. In the prior art, the pure dry sorption methods are more likely to have disadvantages, since dry sorption methods known in practice involve a very high consumption of lime compounds, which is ultimately due to the fact that the lime particles or the exhaust gas treatment reagent do/does not react completely. According to the invention, the subsequent introduction of water vapor into the exhaust gas stream and thus the guarantee of improved reaction kinetics has made it possible to significantly reduce the consumption of the exhaust gas treatment reagent, so that the running operating costs can also be reduced.

In another advantageous embodiment of the exhaust gas treatment method or the method for exhaust gas treatment, the exhaust gas treatment reagent is used as a solid or mixture of solids, in particular in the form of a preferably fine powder. The particulate sulfur oxide-reactive exhaust gas treatment reagent is particularly suitable as a solid or mixture of solids for use in a dry sorption method. In addition, the storage or provision of the exhaust gas treatment reagent is significantly improved in terms of process engineering and economy compared to the prior art, since the solid or mixture of solids can be stored for a longer period of time without losing the sulfur oxide-reactive properties of the exhaust gas treatment reagent or precipitation of the exhaust gas treatment reagent in a solution can be avoided by the particulate form of the exhaust gas treatment reagent, which is configured as a solid or mixture of solids. Furthermore, the finely divided powder is particularly suitable for being introduced into the exhaust gas stream so that the entire exhaust gas stream can absorb the exhaust gas treatment reagent, so that the exhaust gas treatment reagent can be introduced into the exhaust gas stream or the exhaust gases at least essentially evenly distributed in method step (a). In addition, the fine powder is suitable for injection or spraying, without any risk of clogging the injection and/or spraying device. From a process engineering point of view, there are therefore various advantages in using a solid or a mixture of solids as an exhaust gas treatment reagent.

In addition, according to a particularly preferred embodiment it is provided that the exhaust gas treatment reagent is brought into contact with the exhaust gases in fine dispersion and/or is introduced into the exhaust gases. Especially, the exhaust gas treatment reagent is injected and/or sprayed into the exhaust gases in fine dispersion, preferably by means of at least one, preferably lance-shaped, first injection and/or spraying device. More preferably, a multitude of preferably lance-shaped first injection and/or spraying devices is provided. Alternatively or additionally, the exhaust gas treatment reagent can be introduced into the exhaust gases by means of at least one, preferably lance-shaped, first injection and/or spraying device, more preferably by means of a multitude of preferably lance-shaped first injection and/or spraying devices. Especially, the exhaust gas treatment reagent is injected and/or sprayed into the exhaust gases, preferably in fine dispersion.

Preferably, the contacting or introduction, especially the injection and/or spraying, of the exhaust gas treatment reagent into the exhaust gases shall be effected by two to eight preferably lance-shaped injection and/or spraying devices, preferably two to four first lances for introducing the exhaust gas treatment reagent. According to the invention, the exhaust gas treatment reagent is introduced at least essentially evenly distributed in the exhaust gas stream or in the exhaust gases. The fine dispersion of the exhaust gas treatment reagent in the exhaust gases can be achieved by the multitude of the preferably lance-shaped injection and/or spraying devices, since the introduction of the exhaust gas treatment reagent can be carried out in this way adapted to the exhaust gas treatment space, especially the flue and/or exhaust gas duct. Furthermore, it can be provided that the exhaust gas treatment reagent is introduced into the exhaust gases in a conveying flow or in a conveying air flow, so that a conveying air flow can form the carrier for the exhaust gas treatment reagent. It may be provided that the conveying air flow can be introduced into the exhaust gas duct by means of the first lance. Advantageously, the lance-shaped design of the first injection and/or spraying device allows the exhaust gas treatment reagent to be introduced into the central area of the exhaust gas stream—i.e. ultimately into the central area of the flue gas and/or exhaust gas duct through which the exhaust gases flow—and thus, in a targeted and purposeful manner, impact or impingement of the exhaust gas treatment reagent on the walls of the exhaust gas treatment chamber, in particular the exhaust gas and/or flue gas duct, can be at least essentially avoided. Ultimately, it is understood that the exhaust gas treatment reagent can also be incorporated not centrally into the exhaust gas stream, especially at the edges. After introduction in method step (a), the exhaust gas treatment reagent is entrained with the exhaust gas stream, wherein the exhaust gas stream or the exhaust gases now form the carrier for the sulfur oxide-reactive exhaust gas treatment reagent. In addition, the supply of the exhaust gas treatment reagent can also take place and/or be carried out by means of a pneumatic conveyor. The conveying air flow used as carrier for the exhaust gas treatment reagent can originate from the pneumatic conveyor.

According to a particular embodiment, the exhaust gas treatment reagent is at least one sulfur oxide-reactive reagent from the group consisting of alkali metal and/or alkaline earth metal hydroxides, -oxides, -carbonates and -hydrogen carbonates as well as mixtures and combinations thereof, especially from the group consisting of calcium hydroxide, sodium hydrogen carbonate (sodium bicarbonate) and sodium carbonate (soda) as well as mixtures and combinations thereof. Preferably, the exhaust gas treatment reagent contains and/or consists of calcium hydroxide, more preferably in the form of hydrated lime (slaked lime). More preferably the exhaust gas treatment reagent contains or consists of hydrated lime, sodium hydrogen carbonate, sodium carbonate or mixtures or combinations thereof. A particularly preferred exhaust gas treatment reagent is a sulfur oxide-reactive reagent. More preferably the exhaust gas treatment reagent is lime hydrate and/or a reagent containing lime hydrate. Especially, a hydrated lime-containing reagent with at least 50% by weight of hydrated lime, preferably with at least 75% by weight of hydrated lime, more preferably with at least 90% by weight of hydrated lime, based on the hydrated lime-containing reagent. Accordingly, both hydrated lime-containing reagents and hydrated lime-containing residual products can be used as sulfur oxide-reactive exhaust gas treatment reagent, preferably wherein the hydrated lime-containing residual products contain more than 50% by weight alkaline earth metal hydrate.

Furthermore, the exhaust gas treatment reagent may also contain at least one adsorptive reagent, especially a reagent containing activated carbon. The adsorptive reagent may permit the adsorption of, especially toxic, pollutants, especially dioxins. Preferably the exhaust gas treatment reagent comprises a mixture and/or combination of the adsorptive reagent and the sulfur oxide-reactive reagent, especially the reagent containing hydrated lime, especially wherein from 5 to 40% by weight, preferably from 10 to 30% by weight, more preferably from 15 to 25% by weight, of the exhaust gas treatment reagent is the adsorptive reagent. In addition, the adsorptive reagent may also have absorptive properties for the reduction and/or separation of pollutants, especially dioxins. The adsorptive reagent may preferably be activated carbon; other possible adsorptive reagents are selected from the group consisting of zeolites, aluminum oxides, silicon oxides, silicas and silica gels, clathrates, molecular sieves as well as mixtures and combinations thereof.

In principle, it is also conceivable, as mentioned hereinabove, to use sodium bicarbonate or sodium hydrogen carbonate as an exhaust gas treatment reagent. The disadvantage of sodium bicarbonate compared to hydrated lime is the comparatively high material cost. Furthermore, sodium hydrogen carbonate also requires a higher reaction temperature than hydrated lime. Although bicarbonate is generally regarded as a more energy- and resource-saving additive than hydrated lime, it has been shown in accordance with the invention that even when hydrated lime is used in flue gases or exhaust gases from technical processes, which especially have a low moisture content and a comparatively low temperature, efficient and economical exhaust gas treatment can be provided when using hydrated lime. According to the invention, the brief increase in the moisture or water vapor content of the exhaust gas can be carried out in method step (b), wherein a reaction between the exhaust gas treatment reagent and the sulfur oxides contained in the exhaust gases can be ensured.

Nevertheless, bicarbonate or sodium hydrogen carbonate can also be used in other forms, preferably if it would be activated in advance, especially at temperatures in the range of 200 to 1,000° C., preferably in the range of 250 to 450° C. Furthermore, the sodium hydrogen carbonate can also be moistened and/or humidified so that it can be used especially at exhaust gas temperatures of 40 to 60° C. and contributes to the reduction or precipitation of the sulfur oxides in the exhaust gases in method step (b).

In principle, sodium carbonate (soda) is also conceivable as an exhaust gas treatment reagent, although the comparatively high costs of the sodium carbonate would have to be weighed against the separation efficiency, wherein the exhaust gas treatment reagent can be selected according to the composition of the exhaust gas. A reaction with the sulfur oxides contained in the exhaust gases only takes place in method step (b) by increasing the humidity of the exhaust gas and forming a hydrate shell around the particulate exhaust gas treatment reagent, which is present in fine dispersion in the exhaust gas.

The basic reactions between the lime hydrate and the sulfur oxides can be indicated by the gross reaction equations given below:

Ca(OH)₂+SO₂→CaSO₃+H₂O

Ca(OH)₂+SO₃→CaSO₄+H₂O

Furthermore, it is also possible for the hydrated lime, as an exhaust gas treatment reagent, to react with other gaseous pollutants contained in the exhaust gases, as exemplified below:

Ca(OH)₂+2HCI→CaCl₂+2H₂O

Ca(OH)₂+2HF→CaF₂+2H₂O

Ca(OH)₂+CO₂→CaCO₃+H₂O

However, the above-mentioned conversion in method step (a) is so slow that activation becomes necessary. Furthermore, sulfur trioxide has a much higher reactivity than sulfur dioxide and also than carbon dioxide.

By adding steam to the exhaust gas stream, hydrogen fluoride can react with calcium hydroxide to form calcium chloride.

It is also known that it can cause an intermediate reaction of already formed calcium chloride with calcium hydroxide:

Ca(OH)₂+HCl→Ca(OH)Cl+H₂O

Ca(OH)Cl+HCl↔CaCl₂+H₂O.

In dry sorption with hydrated lime as the exhaust gas treatment reagent, the separation of sulfur dioxide in the presence of hydrogen chloride and sulfur dioxide in the exhaust gas stream can be improved compared to separate separation in the sole presence of sulfur oxide. In particular, the intermediate product calcium hydroxy chloride—from the reaction of hydrated lime with hydrogen chloride—also reacts with sulfur dioxide. Calcium hydroxy chloride can also be produced as a residual product in the fabric filter as a result of a reaction between excess hydrated lime with calcium chloride. It is assumed that the calcium hydroxy chloride can react with the sulfur oxides, as the following reaction equations illustrate:

Ca(OH)Cl+SO₂→CaSO₃+HCl

2Ca(OH)Cl+SO₂→CaSO₃+Ca₂Cl₂+H₂O.

For the purposes of the present invention, “hydrate shell” means an attachment of water molecules around an ion. The effective forces here are the ion-dipole interactions. With the formation of hydrogen bonds to the first hydrate shell, further water molecules can attach themselves and thus form another hydrate sphere.

Due to the formation of the hydrate shell, adsorption and absorption processes can run side by side. Here, the hydrate shell can ensure the mass transfer from the gas/particle surface and the pore diffusion by certain dissolving effects, which enable fast ion reactions in the molecular range. Therefore, the presence of HCl, respectively CaCl₂, is an important parameter for a high SO₂-separation efficiency, since the formation of the hydrate shell can use the hygroscopic properties of calcium chloride.

More preferably, the particles of the exhaust gas treatment reagent, especially the hydrated lime particles, serve and/or function as condensation nuclei and/or condensation seeds. The condensation nuclei and/or seeds can facilitate the nucleation and subsequent condensation of the water vapor.

In addition, according to a further preferred embodiment of the inventive concept, it is provided that the exhaust gas treatment reagent has grain sizes, especially particle diameters, below 500 μm, especially below 250 μm, preferably below 100 μm, more preferably below 50 μm, even more preferably in the range from 1 to 50 μm. The aforementioned grain sizes, especially particle diameters, can be determined by sieve analysis. The methods for determining grain sizes, in particular particle diameters, by sieve analysis are standardized, for example in DIN 66165 (DIN 66165-1: “Particle size analysis—sieve analysis—Part 1: Fundamentals” and DIN 66165-2: “Particle size analysis—sieve analysis—Part 2: Performance”).

Preferably, the exhaust gas treatment reagent has average grain sizes D50, in particular particle diameter D50, in the range of 1 to 50 μm. Especially, the average particle size D50 is in the range 1 to 30 μm, preferably in the range 2 to 20 μm, particularly in the range 2 to 15 μm. The average grain size, especially the particle diameter D50, can also be determined by sieve analysis, preferably by sieve analysis in accordance with DIN 66165.

The above-mentioned grain sizes and/or average grain sizes D50 can ensure fine-particle injection and a good reaction between the exhaust gas treatment reagent and the sulfur oxides contained in the exhaust gases. Due to the particulate exhaust gas treatment reagent, preferably in fine dispersion, which has the aforementioned grain sizes and/or average grain sizes D50, a good overall humidification of all particles of the exhaust gas treatment reagent is possible. Furthermore, a fast reaction between the sulfur oxides and the humidified or hydrated exhaust gas treatment reagent in method step (b) can be ensured. Tests have shown that the above-mentioned grain sizes and/or average grain sizes D50 have optimum properties with regard to moistening and/or wetting, preferably of all particles of the exhaust gas treatment reagent, and also require a high deposition rate of sulfur oxides. Furthermore, they can be introduced into the exhaust gas stream in fine dispersion by the first injection and/or spraying device such that the exhaust gas treatment reagent is at least essentially evenly distributed in the exhaust gas stream in method step (a). It is also possible to ensure a favorable ratio between the reaction of the sulfur oxides, which ultimately causes the sulfur oxides to be deposited on the particles of the exhaust gas treatment reagent, and the total quantity of exhaust gas treatment reagent used, with economic process control still being available.

Furthermore, a further embodiment of the invention provides that the exhaust gas treatment reagent has a BET-surface in the range of 5 to 100 m²/g, preferably in the range of 10 to 75 m²/g, particularly in the range of 15 to 50 m²/g. The aforementioned BET-surfaces relate in particular to the sulfur oxide-reactive surface of the exhaust gas treatment reagent. The BET-surface is particularly preferred with respect to the sulfur oxide-reactive and/or acid adsorption-active hydrated lime surface in case of using hydrated lime and/or a hydrated lime-containing reagent as the exhaust gas treatment reagent. Preferably, hydrated lime and/or a hydrated lime-containing product is used as exhaust gas treatment reagent, after which the BET-surface ultimately refers to the hydrated lime and/or hydrated lime containing reagent of the exhaust gas treatment reagent. The aforementioned BET-surfaces enable a high separation efficiency of the sulfur oxides in method step (b). The BET-surface can be determined by a BET measurement in an analytical method for the sizing of surfaces, in particular porous solids, by means of gas adsorption. With this analytical method of surface chemistry, a mass-related specific surface area can be calculated from experimental data. The measurement of the BET-surface (measuring instruments required for this) are described in detail in DIN-ISO 9277 or DIN 66131 (withdrawn). Especially, the BET-surface indicates the surface area of the exhaust gas treatment reagent available for the reaction in relation to the quantity or mass of exhaust gas treatment reagent required for the reaction. Accordingly, the preferred area shows that, in relation to the mass, a large surface area can be provided for the formation of the hydrate shell for a preferably calcium hydroxide containing product.

In a particularly preferred embodiment, the exhaust gas treatment reagent has a total pore volume in the range of from 0.01 to 0.95 m³/g, preferably in the range of from 0.02 to 0.75 m³/g, particularly in the range of from 0.05 to 0.5 m³/g. The above-mentioned total pore volumes result in a good separation performance of the exhaust gas treatment reagent in method step (b) after it has been brought into contact with the water vapor or the already condensed water vapor for separating or reducing the sulfur oxides contained in the exhaust gases. In addition, the above-mentioned total pore volumes are particularly suitable for the introduction into the exhaust gas stream in fine dispersion in method step (a) and also for uniform distribution within the exhaust gas stream. Tests have shown that a total pore volume in the range of from 0.05 to 0.5 m³/g gives the best results in terms of process economy and efficiency.

In addition, a further embodiment of the inventive method envisages that the exhaust gas treatment reagent is used in a stoichiometric excess with respect to the sulfur oxides. An excess of the exhaust gas treatment reagent ensures that the, especially legally prescribed, degree of separation of sulfur oxides can be ensured. The excess of the exhaust gas treatment reagent is due to the fact that tests have shown that not all of the exhaust gas treatment reagent reacts with the sulfur oxides contained in the exhaust gases, as mentioned hereinabove, but only a certain proportion of the exhaust gas treatment reagent. In order to ensure or guarantee the required separation rate of the sulfur oxides, an excess of the exhaust gas treatment reagent is therefore advantageous, since in this way a high separation rate of sulfur oxides can be implemented in the method if the exhaust gas treatment reagent does not react completely with the sulfur oxides. Especially, the exhaust gas treatment reagent is made available to the exhaust gases in a stoichiometric excess of at least 1.05, preferably of at least 1.1, particularly of at least 2, more preferably of at least 3, even more preferably of at least 5, calculated as the stoichiometric ratio of exhaust gas treatment reagent used to reduced and/or separated sulfur oxides.

Preferably, the stoichiometric ratio of exhaust gas treatment reagent to sulfur oxides is in the range of from 1.05:1 to 50:1, especially in the range of from 1.1:1 to 25:1, preferably in the range of from 5:1 to 20:1, particularly in the range of from 8:1 to 12:1, calculated as the stoichiometric ratio of exhaust gas treatment reagent used to reduced and/or separated sulfur oxides. The above-mentioned ratios between the exhaust gas treatment reagent and the sulfur oxides contained in the exhaust gases ensure that the required proportion of sulfur oxides can be separated or removed from the exhaust gases. As mentioned hereinabove, the stoichiometric ratio is caused by the fact that only a certain proportion of the exhaust gas treatment reagent reacts with the sulfur oxides in method step (b), so that an excess of exhaust gas treatment reagent is particularly necessary if a high proportion of sulfur oxides is to be separated or removed from the exhaust gases.

In addition, according to a further embodiment of the invention, it is provided that the amount of water vapor in method step (b) is increased in the exhaust gases containing the exhaust gas treatment reagent—i.e. ultimately in the exhaust gas stream. An increase in the quantity of water vapor and/or the relative humidity of the exhaust gases in method step (b) is ensured by the supply of water vapor and the associated condensation on the exhaust gas treatment reagent. The water vapor content of the exhaust gases increases in the area of the water vapor supply into the exhaust gases. However, this increase is, especially only for a very short period of time and likewise only in the area of the introduction, especially injection and/or spraying, of water vapor into the exhaust gases.

Preferably the amount of water vapor in the exhaust gases containing the exhaust gas treatment reagent—i.e. ultimately in the exhaust gas stream in method step (b)—is increased, especially such that condensation of water on the exhaust gas treatment reagent takes place. Condensation on the exhaust gas treatment reagent occurs in that an increase in the water vapor content of the exhaust gases in method step (b) is caused by supplying the water vapor, wherein condensation of the water vapor is caused by the temperature difference between the, especially colder, exhaust gases and the, especially hotter, water vapor. The condensation is thereby deposited on the particles contained in the exhaust gases and thus also on the particulate exhaust gas treatment reagent, which was previously introduced into the exhaust gas stream in method step (a). According to the invention, condensation on the exhaust gas treatment reagent is particularly advantageous with regard to the separation efficiency of the exhaust gas treatment reagent, since a hydrate shell is formed around the exhaust gas treatment reagent due to the condensation of water vapor on the exhaust gas treatment reagent, as explained above. The hydrate shell formed around the exhaust gas treatment reagent enables a reaction between the sulfur oxides and the exhaust gas treatment reagent, so that a condensation of water vapor in method step (b) can ultimately lead to a higher separation efficiency of the method by increasing the water vapor content of the exhaust gases.

Furthermore, the amount of water vapor in method step (b) can preferably be increased in the exhaust gases containing the exhaust gas treatment reagent—i.e. in the exhaust gas stream in method step (b)—such that the amount of water vapor in the exhaust gases (exhaust gas stream) containing the exhaust gas treatment reagent is increased by at least 0.1% by volume, especially by at least 0.2% by volume, preferably by at least 0.5% by volume, particularly by at least 0.8% by volume, even more preferably by at least 1% by volume. In method step (b), the amount of water vapor in the exhaust gases (exhaust gas stream) containing the exhaust gas treatment reagent is preferably increased such that the amount of water vapor in the exhaust gases (exhaust gas stream) containing the exhaust gas treatment reagent is increased in the range of from 0.1 to 20% by volume, especially in the range of from 0.2 to 15% by volume, preferably in the range of from 0.5 to 10% by volume, more preferably in the range of from 0.8 to 8% by volume, even more preferably in the range of from 1 to 5% by volume.

The above-mentioned increases or the possible ranges for increasing the water vapor content in the exhaust gases in method step (b) refer especially to the location where the water vapor comes into contact with the exhaust gases. The point of contact is particularly in the area of introduction, preferably injection and/or spraying, of the water vapor in method step (b). The increase in the water vapor content of the exhaust gases may also be intended only for a very short time frame or period of time and may ultimately lead to a higher separation efficiency of sulfur oxides due to condensation on the exhaust gas treatment reagent, particularly in the targeted and purposeful manner. An increase in the moisture or water vapor content of the exhaust gases can also be indicated by an increase in the relative humidity of the exhaust gas. An increase in water vapor in the specified ranges is ultimately also an increase in relative humidity. At 100% water vapor by volume in the exhaust gases, saturation is reached and no more additional water vapor can be absorbed into the carrier stream.

The water vapor contents mentioned hereinabove refer especially to a measurement at the temperature of the exhaust gases present in method step (b). The relative air humidity is the quotient of the absolute air humidity and the maximum possible humidity at the measurement temperature (saturation vapor density) or the ratio of the partial pressure of the water vapor and the temperature-dependent saturation vapor pressure. The relative humidity can be determined for example with an absorption hygrometer, an aspiration psychrometer, a dew point hygrometer and/or a hair hygrometer. Generally, devices for measuring air humidity are called hygrometers.

According to a further embodiment of the invention, the amount of water vapor in the exhaust gases containing the exhaust gas treatment reagent—i.e. ultimately in the exhaust gas stream—is increased in method step (b) such that the water vapor content of the resulting exhaust gases (exhaust gas stream) containing the exhaust gas treatment reagent and brought into contact with water vapor is at least 2% by volume, especially at least 3% by volume, preferably at least 4% by volume, particularly at least 5% by volume. It is ultimately understood that the above-mentioned values include the inventive increase of the water vapor content of the exhaust gases containing the exhaust gas treatment reagent in method step (b). As already discussed hereinabove in connection with the increase in the water vapor content of the exhaust gases, the aforementioned relative humidity or water vapor content of the exhaust gases refers only to the place of contact with the water vapor, i.e. ultimately to a locally limited area; especially, for a limited time, to the time of contact. Furthermore, exhaust gases with the aforementioned relative humidity or water vapor content can be classified as dry exhaust gases. Finally, comparatively very dry exhaust gases are treated with water vapor. Despite the introduction of water vapor, a very dry exhaust gas is still present, but it can still be ensured that condensation occurs on the exhaust gas treatment reagent, so that a reaction of the exhaust gas treatment reagent with the sulfur oxides contained in the exhaust gases can be ensured.

In a further preferred embodiment of the invention, in method step (b) the amount of water vapor in the exhaust gases (exhaust gas stream) containing the exhaust gas treatment reagent is increased such that the water vapor content of the resulting exhaust gases (exhaust gas stream) containing the exhaust gas treatment reagent and brought into contact with water vapor is in the range of from 2 to 25% by volume, especially in the range of from 3 to 20% by volume, preferably in the range of from 3.5 to 10% by volume, more preferably in the range of from 4 to 8% by volume. The above-mentioned ranges of values of relative humidity and/or water vapor content in the exhaust gases containing the exhaust gas treatment reagent characterize especially a dry exhaust gas which is treated with water vapor. A drastic increase in the relative humidity and/or the water vapor content in method step (b) does not necessarily have to take place, but it should preferably be ensured that condensation occurs on the exhaust gas treatment reagent according to the invention and/or that a hydrate envelope can form around the particles of the exhaust gas treatment reagent, so that a reaction between the exhaust gas treatment reagent and the sulfur oxides can be ensured. Especially, it is not necessary to ensure that each particle of the exhaust gas treatment reagent reacts with the sulfur oxides; rather, a stoichiometric excess of the exhaust gas treatment reagent can be used to counteract the fact that only a certain percentage of the total amount of the exhaust gas treatment reagent reacts with the sulfur oxides.

In the tests carried out, it was found that, with regard to the formation of the hydrate shell on the exhaust gas treatment reagent, it is particularly advantageous if the water vapor is supplied in the form of saturated vapor in method step (b). Especially, it could be shown that a significantly improved formation of a hydrate shell can be induced with saturated steam, especially compared with superheated steam. Furthermore, the energy costs for the supply of saturated steam can also be reduced compared to the supply of superheated steam, since ultimately the water only has to be heated to the saturated steam temperature. Knowing the pressure prevailing in the exhaust gas treatment chamber in method step (b), the saturated steam temperature to be generated can be inferred.

Additionally, according to a further embodiment of the inventive idea, it is provided that in method step (b) water vapor is supplied in an amount in the range of from 5 to 250 kg/h, especially in an amount in the range of from 6 to 125 kg/h, preferably in an amount of from 10 to 75 kg/h, particularly in an amount in the range of from 18 to 50 kg/h, based on 10,000 standard cubic meters/h (Nm³/h) exhaust gases. A relative indication of the supply of water vapor, preferably saturated steam, in relation to the quantity of exhaust gas results from the fact that a different total quantity of exhaust gases is obtained depending on the technical process to be carried out, which ultimately generates the exhaust gases, and/or the combustion process. The amount of water vapor supplied to the exhaust gases is ultimately configured to ensure that an increase in the water vapor content and/or the relative humidity can be ensured in accordance with the invention, so that a hydrate shell can form around the exhaust gas treatment reagent. It can be particularly important here that the humidity of the exhaust gas is only increased to such an extent that the formation of a hydrate shell in accordance with the invention is successful, but an increase in the water vapor content beyond this is avoided. Furthermore, it should be ensured that the water vapor in a large part of the exhaust gas stream also reaches method step (b). If the amount of water vapor supplied to the exhaust gases were too small, the water vapor would ultimately condense only on those particles of the exhaust gas treatment reagent which would be located closest to the outlet area of the water vapor, especially in the vicinity of the first injection and/or spraying device. The exhaust gas quantity of 10,000 standard cubic meters/h (Nm³/h) is related back to the standard volume and is a volume unit of measurement commonly used in process engineering. After measuring the gas volume, a conversion to the same standard volume is made so that a comparison of exhaust gas volumes with different pressures and/or temperatures can be made. As physical standard state, especially according to DIN 1343, a standard pressure of 101,325 Pa at a standard temperature of 273.15 K is to be regarded. The above-mentioned standard volume in standard cubic meters can refer to the standard physical state according to DIN 1343.

Preferably, the steam is supplied in method step (b) at a temperature in the range of from 110° C. to 185° C., especially in the range of from 120° C. to 170° C., preferably in the range of from 125° C. to 160° C. Especially, the steam can be supplied in method step (b) at a temperature of at least 120° C., preferably at least 130° C., particularly at least 135° C., more preferably at least 140° C. Especially, the above-mentioned temperatures may be fixed on the basis of the saturated steam properties of the water vapor.

In addition, in method step (b) the water vapor can be supplied at a pressure in the range of more than 1 bar to 10 bar, especially in a range of from 2 bar to 8 bar, preferably in the range of from 3 bar to 6 bar. In addition, the water vapor can be supplied alternatively or additionally in method step (b) at a pressure of more than 1 bar, preferably at least 2 bar, particularly at least 3 bar, more preferably at least 4 bar. If the water vapor is in the form of saturated steam, the pressure determines the temperature of the saturated steam. Especially, the pressure of the water vapor can be selected as a function of the pressure in the exhaust gas treatment chamber, especially in the area where the water vapor comes into contact with the exhaust gases. In comparison with the atmospheric pressure, the water vapor is therefore preferably introduced at overpressure.

According to a particularly preferred embodiment of the invention, the addition of exhaust gas treatment reagent, especially in method step (a), and/or the addition of steam, especially in method step (b), preferably the addition of exhaust gas treatment reagent and steam, is regulated and/or controlled as a function of at least one of the following parameters:
(i) content and/or type of sulfur oxides in the exhaust gases to be treated,
(ii) flow velocity of the exhaust gases to be treated,
(iii) temperature of the exhaust gases to be treated,
(iv) water vapor content (humidity) of the exhaust gases to be treated; and
(v) pressure conditions.

A targeted and purpose-oriented addition of exhaust gas treatment reagent and/or water vapor is particularly advantageous in this respect, as a targeted addition is possible depending on the prevailing conditions. Thus, for example, in the case of an increased pollutant content, especially an increased sulfur oxide content in the exhaust gases, the supply of exhaust gas treatment reagent can be increased so that the required separation efficiency of the sulfur oxides can also be ensured. However, the supply of exhaust gas treatment reagent can also be reduced in the same course, provided, for example, that a low sulfur oxide content is present in the exhaust gases. Accordingly, the quantity of the exhaust gas treatment reagent provided can be used in a targeted manner so that an unnecessary surplus of exhaust gas treatment reagent is avoided.

In any case, an unnecessary surplus would become apparent if a required minimum separation efficiency always has to be guaranteed, which is ultimately geared to the higher sulfur oxide loads in the exhaust gas. In the course of this, with an unregulated and/or uncontrolled supply of exhaust gas treatment reagent, the quantity of exhaust gas treatment reagent would always be made available to the exhaust gases that would be required to remove a high sulfur oxide load. By means of regulation and/or control according to the invention, the supply can be controlled depending on the exhaust gases so that the exhaust gas treatment reagent can be dosed in a targeted manner.

It is also advantageous to regulate and/or control the supply of water vapor according to the prevailing conditions, so that an optimized separation rate of sulfur oxides can be guaranteed. Furthermore, the aforementioned parameters either have an influence on the sulfur oxide separation efficiency and/or on the supply of water vapor and/or exhaust gas treatment reagent. For example, when saturated steam is fed in, it is advantageous to know the prevailing pressure in the exhaust gas treatment chamber, especially in method step (b), so that the saturated steam temperature and the pressure of the water vapor can be set and/or controlled as a function of this pressure.

Due to the regulation and/or control system, the separation rate can be improved, while at the same time the running operating costs can be reduced, especially due to a targeted supply of exhaust gas treatment reagent.

Preferably, the water vapor is brought into contact with the exhaust gases in method step (b) in a fine dispersion and/or is introduced into the exhaust gases, especially injected and/or sprayed into the exhaust gases. This can be done by means of at least one, preferably lance-shaped, second injection and/or spraying device, more preferably by means of a multitude of preferably lance-shaped second injection and/or spraying devices. In particular, the water vapor can be introduced into the exhaust gases by means of 2 to 10, preferably 2 to 4, particularly lance-shaped injection and/or spraying devices.

Advantageously, in method step (b), the water vapor is introduced into the exhaust gases by means of at least one preferably lance-shaped second injection and/or spraying device, preferably by means of a multitude of, preferably lance-shaped, second injection and/or spraying devices, especially injected and/or sprayed into the exhaust gases, preferably in fine dispersion. The second injection and/or spraying device is preferably configured such that condensation can be ensured on the exhaust gas treatment reagent so that the hydrate shell necessary for the reaction between the exhaust gas treatment reagent and the sulfur oxides can form on the surface of the exhaust gas treatment reagent. For this purpose, the water vapor is introduced into the exhaust gas stream over the entire cross-section of the exhaust gas treatment chamber, especially the flue gas and/or exhaust gas duct, if possible. The fine dispersion of the water vapor is characterized especially by the fact that the largest possible cross-section of the exhaust gas stream can be mixed with water vapor or that the water vapor can condense on at least 50%, preferably from 50% to 95%, more preferably from 60% to 70%, of the particles of the exhaust gas treatment reagent.

The preferably lance-shaped second injection and/or spraying device can comprise a multitude of openings for the water vapor for the outlet and/or discharge, so that each second injection and/or spraying device can provide individual partial streams of the water vapor to the exhaust gas. Preferably the preferably lance-shaped second injection and/or spraying device comprise 2 to 10, preferably 2 to 4, openings for the outlet and/or discharge. Accordingly, 2 to 4 partial streams of water vapor can be introduced into the exhaust gas stream, preferably in each second injection and/or spraying device. By introducing different partial streams or a multitude of partial streams of the water vapor into the exhaust gas stream or into the exhaust gases, the fine dispersion of the water vapor in the exhaust gases can be ensured, wherein a condensation of water vapor on the surface of a large proportion of the particles of the exhaust gas treatment reagent can be caused.

In addition, in method step (b), the water vapor can be supplied at a velocity of at least 50 m/s, preferably in the range of from 50 m/s to 100 m/s, particularly in the range of from 80 m/s to 120 m/s, especially it can be injected and/or sprayed into the exhaust gases. The velocity is configured or selected especially such that condensation of the water vapor is not only caused in the region of the outlet openings of the preferably lance-shaped second injection and/or spraying device, but that the water vapor can be introduced over as large a region of the cross-section of the exhaust gas stream as possible, so that condensation of water vapor on the exhaust gas treatment reagent can be at least substantially ensured. For this purpose, the water vapor can be introduced into the exhaust gas stream at a much higher velocity, so that ultimately, due to the increased velocity, an introduction of the water vapor into the exhaust gas stream can be guaranteed. If the water vapor were to escape from the preferably lance-shaped second injection and/or spraying device at too low a velocity, the high separation efficiency of the invention could not be guaranteed due to the reaction of the sulfur oxides-reactive exhaust gas treatment reagent.

In accordance with a particularly preferred embodiment, in method step (b) the steam is fed to the exhaust gases and/or the exhaust gas stream at a velocity which is at least twice, preferably at least three times, more preferably four to ten times, especially at least six to seven times, as high as the velocity of the exhaust gases and/or the exhaust gas stream. A higher velocity of the water vapor compared to the velocity of the exhaust gas stream can ensure that the water vapor, preferably in fine dispersion, can be introduced at least substantially uniformly over the cross-section of the exhaust gas stream, especially in the flue gas and/or exhaust gas duct. Preferably, the water vapor is not introduced into the exhaust gases in the direction of flow, so that at an increased velocity of the water vapor, entry into the, preferably micro-turbulent, flow of the exhaust gas stream can be ensured.

In addition, according to a further preferred embodiment of the present invention, it is provided that in method step (b) the water vapor is supplied, especially injected and/or sprayed, with an angle of at least 20°, especially with an angle of at least 30°, preferably with an angle in the range of from 20° to 160°, more preferably with an angle in the range of from 40° to 150°, relative to the direction of the exhaust gas stream. The aforementioned angles make it clear that the water vapor is preferably introduced into the exhaust gases or fed to the exhaust gases at least essentially transversely to the direction of flow of the exhaust gas stream.

Furthermore, especially a supply of the water vapor provided at least essentially transverse to the direction of flow, preferably at a higher velocity than the exhaust gas stream, ensures that the water vapor, preferably finely distributed, can be introduced over a large proportion of the cross-section of the exhaust gas stream. In tests carried out, it could be established that an introduction of the water vapor and/or an arrangement of the second injection and/or spraying device, which is arranged and/or configured such that the water vapor is introduced into the exhaust gas stream at the aforementioned angles, ensures the best possible wetting of the exhaust gas treatment reagent contained in the exhaust gases with water and thus a very high separation rate of sulfur oxides.

In addition, according to a further preferred embodiment of the present invention, it is provided that the exhaust gases and/or the exhaust gas stream are/is guided along at least essentially without backflow and/or at least essentially without back-mixing in the area of the, preferably lance-shaped, second injection and/or spraying device for the water vapor. Especially, the outlet area of the second injection and/or spraying device for the water vapor is at least essentially without a backflow and/or at least essentially without back-mixing of the exhaust gases and/or the exhaust gas stream. This proves to be particularly advantageous in that exhaust gas treatment reagent which has not already been brought into contact with water vapor and/or water enters the region of the outlet opening of the second injection and/or spraying device, which could not be prevented in the event of possible back-mixing or backflow of the exhaust gas stream. Disadvantageous consequences in case of back-mixing and/or backflow of the exhaust gases would be that exhaust gas treatment reagent which has already been brought into contact with water and/or water vapor and which may have already been converted by a reaction with sulfur oxides could lead to caking or agglomerations on the second injection and/or spraying device—especially in the region of the outlet opening, so that “clogging” of the second injection and/or spraying device could be caused at the expense of the separation rate and/or the service life of the exhaust gas treatment system.

In addition, especially the exhaust gas treatment method according to the invention can be configured such that in method step (b) the water vapor is supplied in a region of the exhaust gases which is at least essentially free of exhaust gas treatment reagent Preferably, the, preferably lance-shaped, second injection and/or spraying device for the water vapor is kept free and/or sealed off (isolated) from exhaust gas treatment reagent, especially by means of at least one displacer body, especially in the form of a diaphragm, especially a perforated diaphragm, or a plate, especially a baffle or deflector plate. Especially, the outlet area for the water vapor of the second injection and/or spray device is kept free of exhaust gas treatment reagent. This means that caking or agglomerations on the second injection and/or spraying device and/or on other plant components can be at least essentially avoided. Especially, exhaust gas treatment reagent already in contact with water vapor can lead to caking or agglomerations on plant components and thus cause considerable damage to the entire exhaust gas treatment system.

According to the invention, the possible disadvantages of the supply of water vapor downstream and/or downstream in the direction of the method relative to the supply of the exhaust gas treatment reagent, which would ultimately be reflected in a clogging of the nozzles for the water vapor, can be effectively counteracted.

Furthermore, the exhaust gases and/or the exhaust gas stream can be deflected and/or swirled between method step (a) and method step (b), especially between the supply of the exhaust gas treatment reagent and the water vapor. The swirling and/or deflection can be provided for better mixing of the exhaust gas stream with the exhaust gas treatment reagent, so that the exhaust gas treatment reagent can be provided in fine dispersion uniformly in the exhaust gas stream. Additionally, preferably at least one displacer is used for deflecting and/or swirling the exhaust gases and/or the exhaust gas stream. Especially, the displacer body has the form of an orifice plate, especially a perforated orifice plate, or a plate, especially a baffle or baffle plate. The displacer is preferably used for mixing the exhaust gases containing the exhaust gas treatment reagent (the exhaust gas stream) and the exhaust gas treatment reagent Especially, the displacer body is provided for generating an area of the exhaust gases at least essentially free of exhaust gas treatment reagent for the supply of the water vapor. The displacer body can preferably be arranged such that the outlet of the water vapor is carried out in an at least essentially particle-free and/or dust-free region, so that caking or agglomerations in the region of the water vapor discharge openings in method step (b) can be avoided.

In case of a particularly preferred embodiment, the amount of water vapor and/or the relative humidity in the exhaust gases—i.e. in the exhaust gas stream—is reduced subsequently to method step (b) and/or after the water vapor has been added. Accordingly, a brief increase in the water vapor can preferably be provided in method step (b), which can ultimately result in the water vapor condensing on the exhaust gas treatment reagent, wherein after condensation the water vapor content of the exhaust gases decreases again.

Especially, the proportion of water vapor in the exhaust gases decreases such that the water vapor content of the exhaust gases (exhaust gas stream) is at least 1% by volume, especially at least 2% by volume, preferably at least 3% by volume, more preferably at least 4% by volume.

Furthermore, in a further advantageous embodiment of this aspect of invention, it is provided that subsequently to method step (b) and/or after the water vapor has been supplied, the amount of water vapor in the exhaust gases (exhaust gas stream) is reduced, especially such that the water vapor content of the exhaust gases (exhaust gas stream) is in the range of from 1 to 24% by volume, especially in the range of from 2 to 19% by volume, preferably in the range of from 2.5 to 9% by volume, more preferably in the range of from 3 to 7% by volume. It is particularly preferred that the water vapor content of the exhaust gases is reduced such that it corresponds at least essentially to the water vapor content of the exhaust gases in method step (a). A low moisture content of the exhaust gases after method step (b) is advantageous for the subsequent treatment of the exhaust gases, especially the filtering or mechanical separation of the pollutants.

The above-mentioned proportions of water vapor in the exhaust gas stream ultimately characterize a very dry exhaust gas, so that the addition of water vapor to achieve a desired condensation on the particles of the exhaust gas treatment reagent is particularly advantageous, since otherwise condensation is comparatively unlikely due to the water vapor content already present in the exhaust gas and/or occurs only on less than 5% of the particles of the exhaust gas treatment reagent.

Advantageously, the water vapor content of the exhaust gases to be treated is at least 1% by volume, especially at least 2% by volume, preferably at least 3% by volume, more preferably at least 4% by volume. Otherwise, the water vapor content of the exhaust gases to be treated is preferably in the range of from 1 to 24% by volume, especially in the range of from 2 to 19% by volume, preferably in the range of from 2.5 to 9% by volume, more preferably in the range of from 3 to 7% by volume.

“Exhaust gases to be treated” shall mean the original exhaust gases resulting from the technical process step and/or combustion. Accordingly, the exhaust gases to be treated are fed to method step (a) and therefore the exhaust gases before method step (a) have the aforementioned water vapor content. As already explained hereinabove, the above-mentioned ranges and minimum specifications of the water vapor content show that, preferably after method step (b) and/or after the addition of the water vapor, the water vapor content of the exhaust gases can ultimately drop to the value which it had before the exhaust gas treatment was carried out, especially before method step (a) was carried out.

According to a special embodiment, the exhaust gases to be treated are from smelters, especially copper smelters and/or iron smelters, cement plants, steel plants or power plants, preferably hard coal plants. Furthermore, the exhaust gases to be treated may be from raw iron and/or steel production by means of sintering iron ores and subsequent raw iron production in the blast furnace process. Furthermore, the exhaust gases to be treated may be from smelters, especially copper smelters and/or iron smelters, cement plants, steel plants or power plants, preferably hard coal plants, and/or from raw iron and/or steel production by means of sintering of iron ores and subsequent raw iron production in the blast furnace process.

The aforementioned exhaust gases may contain a large proportion of sulfur oxides or pollutants to be separated in the exhaust gases, making them particularly suitable for the exhaust gas treatment method according to the invention. Furthermore, the above-mentioned exhaust gases preferably have a very low water vapor content, especially in the range of from 1 to 10% by volume, so that without the supply of water vapor in accordance with the invention in a method step downstream from the supply of the exhaust gas treatment reagent, no condensation would occur on the particles of the exhaust gas treatment reagent to form a hydrate shell. Ultimately, therefore, the reaction kinetics between the exhaust gas treatment reagent and the sulfur oxides would be inadequate without the addition of water vapor and would necessitate a high consumption of exhaust gas treatment reagent, since the latter would be added in a superstoichiometric ratio which clearly exceeds the superstoichiometric ratio of the method according to the invention.

In addition, in a further embodiment of the method it is provided that in method step (a) and/or in method step (b) the temperature of the exhaust gases (exhaust gas stream) is at least 15° C., especially at least 20° C., preferably at least 30° C., more preferably at least 40° C. Furthermore, in method step (a) and/or in method step (b), the temperature of the exhaust gases (exhaust gas stream) can be in the range of from 15 to 600° C., especially in the range of from 20 to 400° C., preferably in the range of from 30 to 150° C., more preferably in the range of from 40 to 60° C. Especially, the exhaust gases have a comparatively low temperature compared with exhaust gases originating from a technical method step.

However, other state-of-the-art exhaust gas treatment methods for separating the sulfur oxides require a higher temperature, so that the exhaust gases would have to be heated up, which would ultimately increase not only energy consumption but also operating costs. According to the invention, the original exhaust gases or those to be treated can have a temperature in the range of from 40 to 60° C. with a, preferably very low, water vapor content of less than 15% by volume. Especially at a temperature in the range of from 40 to 60° C. with a water vapor content of the exhaust gases to be treated of at least essentially 5% by volume or lower, the method according to the invention proves to be particularly advantageous, since without heating the exhaust gases and without a longterm increase in the water vapor content—the water vapor is only briefly increased in method step (b) to form a hydrate shell on the particles of the exhaust gas treatment reagent—a high separation efficiency of the sulfur oxides can be ensured.

Advantageously, the exhaust gas stream in method step (b) has a velocity of at least 1 m/s, preferably in the range of from 2 m/s to 100 m/s, preferably in the range of from 2 m/s to 20 m/s, more preferably in the range of from 10 m/s to 20 m/s. The above-mentioned velocity depends especially on the respective process management and likewise also on the origin of the exhaust gases, for example the combustion process and/or the technical process step. Especially, the aforementioned velocities make it clear that, according to the invention, the water vapor is preferably introduced at a much higher velocity than the velocity of the exhaust gas stream. Furthermore, the velocity is also configured especially such that in method step (a), the introduction of the exhaust gas treatment reagent can be ensured in which the exhaust gas treatment reagent is present at least essentially evenly distributed within the exhaust gas stream. In addition, the water vapor can also be introduced into the exhaust gas stream in method step (b) or fed to it, so that condensation is caused on the particles of the exhaust gas treatment reagent.

In another preferred embodiment of the invention, the exhaust gases containing the exhaust gas treatment reagent are passed through at least one turbulence section, especially a venturi section, before the water vapor is supplied in method step (b) and/or after the exhaust gas treatment reagent is brought into contact with the exhaust gases in method step (a). Especially, the venturi section and/or the turbulence section is arranged between method step (a) and method step (b). The turbulence section is preferably configured such that the exhaust gas stream is mixed with the exhaust gas treatment reagent, especially so that the exhaust gas treatment reagent is present in the exhaust gas stream at least essentially evenly distributed. Furthermore, the turbulence section can be configured such that the discharge and/or release opening and/or the discharge and/or release openings for the water vapor of the second injection and/or spraying device is/are kept at least substantially free of dusty particles and/or free of the exhaust gas treatment reagent. For example, a narrowing and/or reduction of the flue gas and/or exhaust gas duct cross-section of the exhaust gas treatment chamber can be used as a venturi section. In addition, in method step (b) and/or upstream of method step (b), the flue gas and/or exhaust duct cross-section of the exhaust gas treatment chamber can also be widened and/or enlarged so that ultimately the constriction is only traversed by the exhaust gases or the exhaust gas stream only between method step (a) and method step (b). A relatively high velocity of the exhaust gases prevails in the venturi section and/or within the turbulence section, after which a fast and very good mixing of the exhaust gases and the exhaust gas treatment reagent can result. The pollutant emissions can also be greatly reduced by improved mixing, since the exhaust gas treatment reagent is finely and evenly distributed in the exhaust gas stream and can therefore react with the sulfur oxides contained in the exhaust gases in method step (b) due to the water vapor.

Advantageously, the exhaust gas treatment in method step (a) and method step (b) is carried out in the presence of oxygen. Especially, the oxygen does not have to be expensively removed from the exhaust gases in advance, which would ultimately increase both energy costs and operating costs. At the same time, an air stream (containing oxygen) can also be used as a feed stream for the exhaust gas treatment reagent.

In a particularly preferred embodiment of the invention, the exhaust gases are subjected to filtering after the water vapor has been supplied in method step (b) and/or after method step (b). Especially, the filtering serves to separate the reaction products of the reacted exhaust gas treatment reagent and/or of unreacted exhaust gas treatment reagent as well as further pollutants and/or dusty or particulate components contained in the exhaust gases. In addition, the exhaust gases can be fed to a filter device, preferably a fabric filter. The solids and/or pollutants contained in the exhaust gases, especially solid and/or dusty particles, preferably unreacted exhaust gas treatment reagent and/or reaction products of the reacted exhaust gas treatment reagent, can be separated off and/or separated from the exhaust gases. In addition, calcium hydroxy chloride may be formed as a residual product from the fabric filter as a result of a reaction between excess lime hydrate and calcium chloride.

The fabric filter and/or the filter device is cleaned especially in cyclic intervals so that the components of the exhaust gases deposited on the fabric filter are separated from the filter device as so-called “filter cake”. The basic task of the filter device and/or the fabric filter can ultimately be to separate the dust particles from the exhaust gases, for example the flue gases. The components of the exhaust gases to be separated can deposit on the filter material and thus create the filter cake, which can ultimately also act as a separator. Regular regeneration is particularly necessary to ensure the required pressure conditions, e.g. by means of a com-pressed air pulse introduced against the direction of flow, which causes the filter cake to be ejected.

The flow to the filter can be selected and/or adjusted to provide optimum sorption conditions. This also applies to the cleaning cycle of the fabric filter, within which the filter cake is separated.

In another preferred embodiment of the method, the unreacted exhaust gas treatment reagent and/or the reacted exhaust gas treatment reagent is/are recycled, preferably after filtration in the filter device and/or fabric filter. Especially, a recycling can enable a renewed use of the exhaust gas treatment reagent, preferably of the unreacted exhaust gas treatment reagent, and thus reduce the amount of exhaust gas treatment reagent required by the method according to the invention, which cannot subsequently be further used for the method according to the invention, whereby the operating costs can be significantly reduced.

Advantageously, the exhaust gas treatment method according to the invention can be used for the treatment of exhaust gases from smelters, especially copper smelters and/or iron smelters, cement plants, steel plants or power plants, preferably hard coal plants, and/or for the treatment of exhaust gases originating from raw iron and/or steel production by means of sintering iron ores and subsequent raw iron production in the blast furnace process. Especially, the exhaust gas treatment method can be very easily integrated into existing smelters and/or power plants into the existing exhaust gas treatment plant, usually the exhaust gas treatment plant already contains a fabric filter as well as an injection and/or spraying device for an additive of the dry sorption method. The inventive introduction and/or supply of water vapor, which is provided downstream in the process direction following the supply of the exhaust gas treatment reagent, can thus lead to a significant improvement in the separation efficiency with respect to the sulfur oxides without the need for expensive conversion measures to carry out the inventive method. Especially, the already existing flue gas and/or exhaust gas duct of the exhaust gas treatment chamber can be used for the arrangement of the first and/or second injection and/or spraying device.

In addition, the water vapor now introduced in method step (b) can form a hydrate shell in the exhaust gas around the exhaust gas treatment reagent particles, which are preferably in the form of solids, which greatly improves the reaction kinetics compared to pure dry sorption.

In the prior art, different theoretical considerations have been made with regard to the formation of the hydrate shell and to improving the separation of the exhaust gas treatment reagent due to an increased relative humidity in the exhaust gas, which all have in common that the separation efficiency of sulfur oxides can be significantly improved by using a calcareous exhaust gas treatment reagent in which the water vapor content in the exhaust gas is increased. However, what has been completely ignored in the prior art is, as explained above, that the water vapor should be downstream or in the process direction downstream from the introduction of the exhaust gas treatment reagent in order to achieve the essential advantages of the invention while avoiding the disadvantages known in the prior art. This could only be shown by the invention and the tests carried out in the course of the invention.

A further object of the present invention—according to a second aspect of the present invention—is a system (installation, plant) for the treatment of sulfur oxides (SOₓ)-containing exhaust gases from technical processes for the purpose of removing and/or separating off the sulfur oxides and/or for the purpose of reducing the sulfur oxide content, especially a system for carrying out a method for treating sulfur oxides (SOx)-containing exhaust gases from technical processes for the purpose of removing and/or separating off the sulfur oxides and/or for the purpose of reducing the sulfur oxide content, preferably for carrying out a method according to any of the previously described embodiments and/or according to the first aspect of the present invention,

wherein the plant system comprises a device for carrying out a technical process generating sulfur oxides-containing exhaust gases,

wherein an exhaust gas treatment device for exhaust gas treatment of the sulfur oxide-containing exhaust gases produced in the device is associated with the device and/or wherein an exhaust gas treatment device for exhaust gas treatment of the sulfur oxide-containing exhaust gases produced in the device is connected downstream from the device and/or is provided downstream from the device in the direction of the method,

wherein the exhaust gas treatment device comprises an exhaust gas treatment chamber, preferably in the form of a duct,

wherein the exhaust gas treatment chamber comprises and/or is divided into at least a first section and, downstream from the first section and/or downstream from the first section in the direction of the method, a second section, wherein the exhaust gas treatment device comprises
(A) arranged and/or located in the first section of the exhaust gas treatment chamber, at least one first injection and/or spraying device for bringing into contact and/or supplying, especially injecting and/or spraying, an exhaust gas treatment reagent with the exhaust gases containing the sulfur oxides, wherein the first injection and/or spraying device is configured such that an exhaust gas stream containing the exhaust gas treatment reagent is obtained, and,
(B) arranged and/or located in the second section of the exhaust gas treatment chamber and arranged downstream and/or downstream from the first injection and/or spraying device in the direction of the method, at least one second injection and/or spraying device for bringing into contact and/or supplying, especially injecting and/or spraying, water vapor with the exhaust gas stream containing the exhaust gas treatment reagent, especially wherein the second injection and/or spraying device is configured such that the exhaust gas treatment reagent is reacted with the sulfur oxides contained in the exhaust gases.

Within the framework of the inventive system, it is provided especially that the system is configured for carrying out the exhaust gas treatment method according to the first aspect of the present invention, wherein it is ultimately understood that the plant can also be configured for carrying out the preferred embodiments of the exhaust gas treatment method in further embodiments.

As described hereinabove, the introduction and/or supply of the water vapor is provided downstream in the direction of the method and/or following the introduction and/or supply of the exhaust gas treatment reagent via the first injection and/or spraying device and/or supply of the water vapor via the second injection and/or spraying device enables the formation of a hydrate shell around the particles of the exhaust gas treatment reagent. In this way, a higher reaction kinetics of the reaction of the particles of the exhaust gas treatment reagent, which preferably contain lime, with the sulfur oxides contained in the exhaust gases can be made possible. Especially, the particles of the exhaust gas treatment reagent can act as condensation nuclei.

The exhaust gas treatment device can therefore ensure a high separation efficiency of the sulfur oxides by placing the second injection and/or spraying device in the second section, which is downstream and/or downstream from the first section in the direction of the method. Accordingly, the exhaust gas treatment area is separated and/or subdivided into at least two areas, wherein firstly a supply of the exhaust gas treatment reagent and then a supply of water vapor is provided; in each case by injection and/or spraying devices provided for this purpose. The exhaust gas treatment device according to the invention is characterized especially by the fact that it can be integrated with little effort and low investment costs into an already existing exhaust gas treatment device, especially for the exhaust gas treatment of smelters. Consequently, the system in accordance with the invention can be maintained by a simple retrofit, thus achieving a high separation efficiency of sulfur oxides and a significant reduction in operating costs.

With respect to further details as to the system according to the present invention, reference may be made to the above description of the exhaust gas treatment method according to the invention, which applies accordingly also to this aspect of the present invention.

According to a particularly preferred embodiment, the exhaust gas treatment device is configured such that the sulfur-containing oxides exhaust gases are subjected to an exhaust gas treatment, especially a desulfurization, by means of at least one particulate exhaust gas treatment reagent reactive to sulfur oxides, especially desulfurization reagent.

Furthermore, according to a preferred embodiment, the first injection and/or spraying device may be configured for contacting and/or introducing, especially for injecting and/or spraying, the exhaust gas treatment reagent in fine dispersion with and/or into the exhaust gas(es). A fine dispersion of the exhaust gas treatment reagent in the exhaust gas stream is advantageous especially for the uniform distribution of the particles of the exhaust gas treatment reagent in the exhaust gas stream, whereby an increased separation efficiency of the sulfur oxides can be ensured. Therefore a high proportion of the exhaust gas treatment reagent particles can react with the sulfur oxides in the second section.

In addition, the first injection and/or spraying device comprises at least one, preferably 2 to 8, first lance(s) for introducing, especially injecting and/or spraying, the exhaust gas treatment reagent into the exhaust gases containing the sulfur oxides. A first lance is particularly advantageous in that a supply of the exhaust gas treatment reagent can be provided in a targeted manner in the exhaust gas stream and thus the distribution of the exhaust gas treatment reagent in the exhaust gas stream through the first lance can also be specified in a targeted and purposeful manner. Especially, the first lance is configured such that it can make the exhaust gas treatment reagent available to the exhaust gases by means of a conveying flow, especially a conveying air flow, the conveying air flow acting as a carrier for the exhaust gas treatment reagent and being able to be introduced via the first lance into the first section of the exhaust gas treatment space, preferably into the flue gas and/or exhaust gas duct. The first lance can be configured such that the particles of the exhaust gas treatment reagent emerging from the first lance are deflected and can flow through the first section together with the exhaust gas stream.

Furthermore, preferably the second injection and/or spraying device comprises at least one, preferably 2 to 8, second lance(s) for the introduction, especially injection and/or spraying, of water vapor into the exhaust gases. The second lance is configured especially such that the water vapor can penetrate as deeply as possible into the exhaust gas stream and/or can be distributed over as large an area as possible of the cross-section of the second section of the exhaust gas treatment chamber, especially the channel cross-section. Especially, the water vapor can be introduced into the exhaust gases over at least 20%, preferably from 20% to 80%, more preferably from 30% to 50%, of the cross-section of the exhaust gas treatment chamber in the second section, preferably in the region of the second injection and/or spray device.

In addition, the second lance may comprise a multitude of openings, preferably in the range of from 2 to 8 openings, particularly in the range of from 2 to 4 openings, for discharging and/or releasing the water vapor. A multitude of openings gives a multitude of partial flows of the water vapor which can be introduced into the exhaust gases. A multitude of partial flows allows a larger area of the second section of the exhaust gas treatment chamber to be brought into contact with the water vapor. Especially, a larger proportion of the particles of the exhaust gas treatment reagent contained in the exhaust gases can thus have a hydrate shell and/or act as condensation nuclei, wherein the formation of the hydrate shell can be initiated by the water vapor.

Furthermore, in accordance with a further preferred embodiment, the first injection and/or spraying device, especially the first lance, can be configured and/or arranged such that the exhaust gas treatment reagent is supplied, especially injected and/or sprayed, into the first section of the exhaust gas treatment space at an angle in the range of from −30° to 30°, especially at an angle in the range of from −20° to 20°, more preferably at an angle in the range of from −10° to 10°, relative to the direction of the exhaust gas stream, preferably at least essentially in the direction of flow. The aforementioned angle may ultimately relate to the direction of flow of the exhaust gas stream. The flow direction refers in particular to the main flow direction of the exhaust gas stream. Between a negative and a positive angle, the flow direction, especially the main flow direction, can be arranged in the 0° position. In analogy to the positive angle, for example a negative angle of −20° can also be specified as 340°. The introduction and/or supply of the exhaust gas treatment reagent at least essentially in the direction of flow ensures that the particles of the exhaust gas treatment reagent can be “entrained” or carried along by the exhaust gas stream such that they are conveyed through the exhaust gas treatment chamber by means of the exhaust gas stream.

Furthermore, according to a further preferred embodiment of the invention, it may be provided that the second injection and/or spraying device, especially the second lance, is configured and/or arranged such that the water vapor is supplied, especially injected and/or sprayed, in the second section of the exhaust gas treatment chamber at an angle of at least 20°, especially at an angle of at least 30°, preferably at an angle in the range of from 20° to 160°, more preferably at an angle in the range of from 40° to 150°, relative to the direction of the exhaust gas stream. Especially, it is provided that the second lance of the second injection and/or spraying device is arranged such that the outlet opening and/or the outlet openings are arranged at least essentially transversely, i.e. at a 90° angle, to the direction of flow, especially the main flow direction of the exhaust gas stream. An introduction of the water vapor provided at least essentially transversely to the direction of flow has the advantage that the water vapor can penetrate into the exhaust gas stream due to its preferably higher velocity, so that ultimately a large proportion of the cross-section of the exhaust gas treatment chamber can be brought into contact with water vapor. This would be difficult to achieve and/or implement if the water vapor were introduced and/or fed in the direction of flow of the exhaust gas stream. If the water vapor is introduced in the direction of flow of the exhaust gas stream, the water vapor could not be distributed over a large proportion of the cross-section of the exhaust gas treatment chamber, as envisaged in the invention. It is understood that in the case of a multitude of second injection and/or spraying devices, these may be arranged above and below the flow device, especially the main flow direction and/or the main flow device, in the aforementioned angular ranges.

Preferably in the case of a multitude of second injection and/or spraying devices and/or first injection and/or spraying devices, these may be arranged opposite one another, especially wherein the respective adjacent devices may form an angle of preferably 100° to 250°, more preferably 150° to 200°, with one another.

In a particularly preferred embodiment, at least one displacement body, especially in the form of an orifice plate, especially a perforated orifice plate, or a metal sheet, especially a baffle plate, and/or a turbulence section, preferably a venturi section, is arranged between the first injection and/or spraying device and/or the first section of the exhaust gas treatment chamber on the one hand and the second injection and/or spraying device and/or the second section of the exhaust gas treatment chamber on the other hand. The displacement body and/or the turbulence section, especially the venturi section, are configured to deflect and/or swirl the exhaust gases and/or the exhaust gas stream. A swirling and/or deflection of the exhaust gases can be provided such that a good mixing of the exhaust gas stream with the particles of the exhaust gas treatment reagent takes place. Furthermore, the swirling and/or deflection of the exhaust gases can be provided to produce an area at least essentially free of exhaust gas treatment reagent for the supply of the water vapor, preferably in the area of the water vapor discharge openings of the second injection and/or spraying device. The advantages of an area free of exhaust gas treatment reagent for the supply of the water vapor have already been explained in detail in the description of the method according to the invention, so that it is dispensed with at this point to avoid unnecessary repetition.

Preferably a filter device is arranged downstream and/or downstream in the direction of the method to the second injection and/or spraying device and/or the second section of the exhaust gas treatment chamber. In addition, a fabric filter can also serve as a filter device, which is configured such that the products of the reacted exhaust gas treatment reagent and/or the non-reacted exhaust gas treatment reagent as well as further dust-like particles can be separated on it. Furthermore, the filter device can be cleaned in cyclic intervals, which can be specified especially by a control device coupled to the filter device. Furthermore, the filter device can be configured for filtering the exhaust gases, preferably for separating and/or separating off the solids and/or pollutants contained in the exhaust gas, especially solid and/or dusty particles, preferably of unreacted exhaust gas treatment reagent and/or reaction products of the reacted exhaust gas treatment reagent. Advantageously, the sulfur oxides can thus be at least essentially separated and/or precipitated from the exhaust gases by the filter device, wherein subsequent disposal and/or recycling of the substances deposited on the filter device can be provided for. Especially, a so-called filter cake—as already implemented in the exhaust gas treatment method according to the invention—deposits on the filter device, which should be separated and/or removed from the filter device at cyclic intervals. This filter cake can then be disposed of properly.

Furthermore, in a further preferred embodiment of the invention, especially downstream and/or downstream in the direction of the method to the filter device, a recycling device is provided. The recycling device can be configured such that the unreacted exhaust gas treatment reagent and/or the reacted exhaust gas treatment reagent is/are recycled, preferably after filtering in the filter device and/or the fabric filter. Especially, recycling can enable the exhaust gas treatment reagent, preferably the unreacted exhaust gas treatment reagent, to be reused, resulting in a reduction in operating costs.

In another advantageous embodiment of the invention, a first reservoir device is provided for the storage and/or stocking of the exhaust gas treatment reagent. Preferably, recycled exhaust gas treatment reagent from the recycling device can be fed to the first reservoir device. The first reservoir device may be provided especially for the supply of exhaust gas treatment reagent to the first injection and/or spraying device. Furthermore, the first reservoir device can preferably be associated with the first injection and/or spraying device, preferably wherein the first reservoir device is connected to the first injection and/or spraying device. In the first reservoir device, the exhaust gas treatment reagent can advantageously be stored safely, especially in the dry state of the exhaust gas treatment reagent. Especially, the reservoir device can be coupled to a control device for the targeted and purposeful supply of the exhaust gas treatment reagent, the control device being able to control and/or regulate the supply of the exhaust gas treatment reagent, preferably also of the water vapor. By stockpiling the exhaust gas treatment reagent in the first reservoir device it can be ensured that there is always sufficient capacity for the exhaust gas treatment reagent during operation of the system, especially of the exhaust gas treatment device.

In addition, a second reservoir device may preferably be provided for the storage and/or stockpiling of water and/or water vapor, especially for the supply of water and/or water vapor to the second injection and/or spraying device. Especially, the second reservoir device may be associated with the second injection and/or spraying device, preferably wherein the second reservoir device is connected to the second injection and/or spraying device. Furthermore, a heating device for generating the water vapor can be connected to the second reservoir device and/or the second injection and/or spraying device, especially if water is stored in the second reservoir device. The heating device can be configured such that water can be supplied to it through the second reservoir device and it can heat this water to saturated steam. The heating device can then make this saturated steam available to the second injection and/or spraying device. As already explained above, the second reservoir device and/or the heating device and/or the second injection and/or spraying device can be coupled to a control device for controlling and/or regulating, especially for supplying the water vapor, especially wherein the temperature, the pressure and the quantity of water vapor to be supplied can be predetermined by the control device. By a targeted and purposeful supply of water vapor, an optimization of the system according to the invention and/or of the exhaust gas treatment method according to the invention can take place, preferably with regard to the formation of the hydrate shell and/or the increase in separation efficiency.

Furthermore, other preferred embodiments provide that the system according to the second aspect of the present invention, especially according to one of the embodiments described hereinabove, is characterized by the features of the first aspect of the present invention, especially the preferred embodiments of the exhaust gas treatment method according to the first aspect of the present invention.

A further subject matter of the present invention—according to a third aspect of the present invention—is the use of the method (exhaust gas treatment method), especially according to the first aspect of the present invention, and/or the system, especially according to the second aspect of the present invention, for the purification of sulfur-oxide-containing exhaust gases from smelters, especially copper smelters and/or iron smelters, cement plants, steel plants or power plants, preferably hard coal plants, and/or for the treatment of exhaust gases originating from raw iron and/or steel production by means of sintering iron ores and subsequently exhaust gases originating from raw iron production in the blast furnace process

Furthermore, in an advantageous embodiment of this aspect of the invention, it is provided that the use according to the invention is characterized by one or more features of the method according to the invention (exhaust gas treatment method), especially according to the first aspect of the present invention, and/or the system according to the invention, especially according to the second aspect of the present invention. Accordingly, the use is preferably provided such that one of the preferred embodiments of the method (exhaust gas treatment method) and/or the system is provided.

For further details on the use of the invention, reference can be made to the above explanations regarding the other aspects of the invention, which also apply correspondingly to the use of the invention.

For further details on this aspect of the invention, reference can be made to the above explanations on other aspects of the invention in order to avoid unnecessary repetition.

It shows:

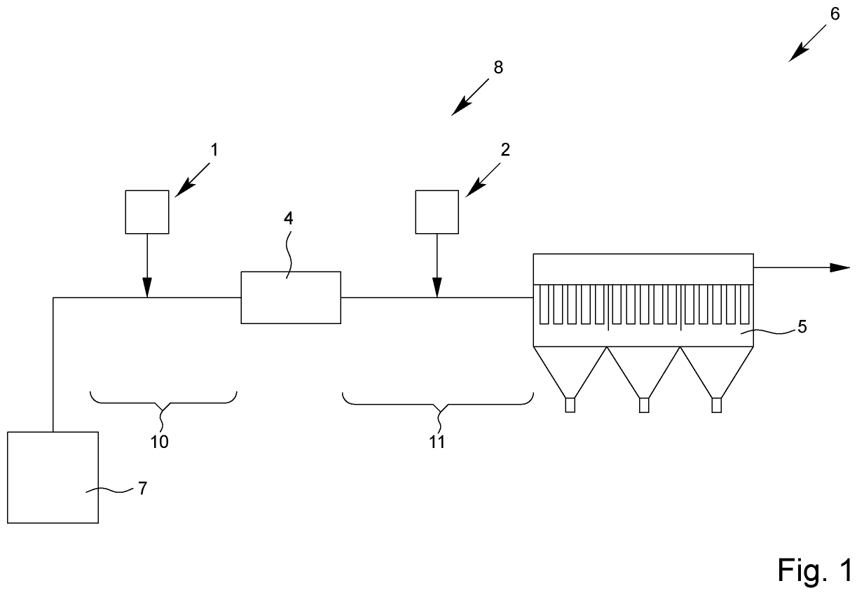

FIG. 1 schematic representation of an inventive system according to a particular embodiment of the present invention;

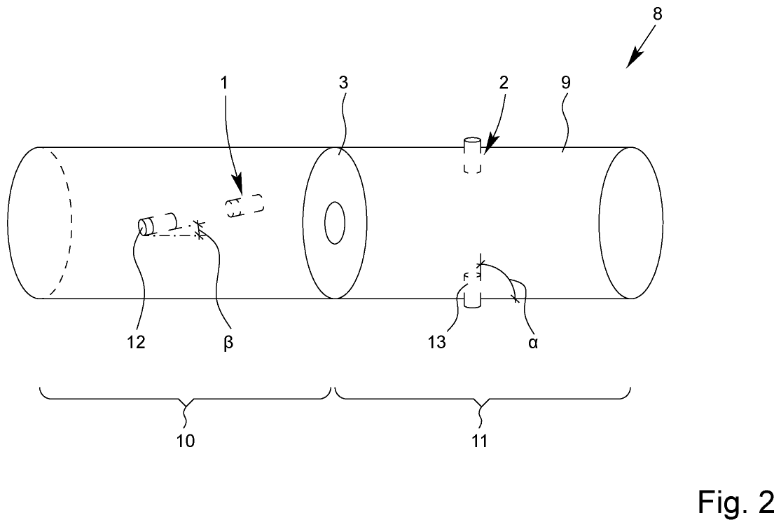

FIG. 2 schematic representation of an exhaust gas treatment device according to a special embodiment of the present invention;

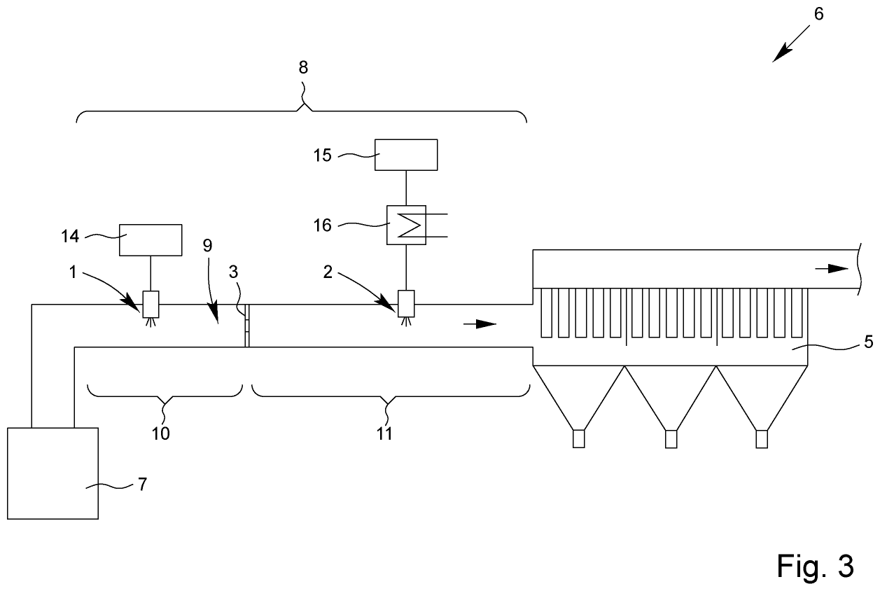

FIG. 3 schematic representation of an inventive system in accordance with a particular embodiment of the present invention;

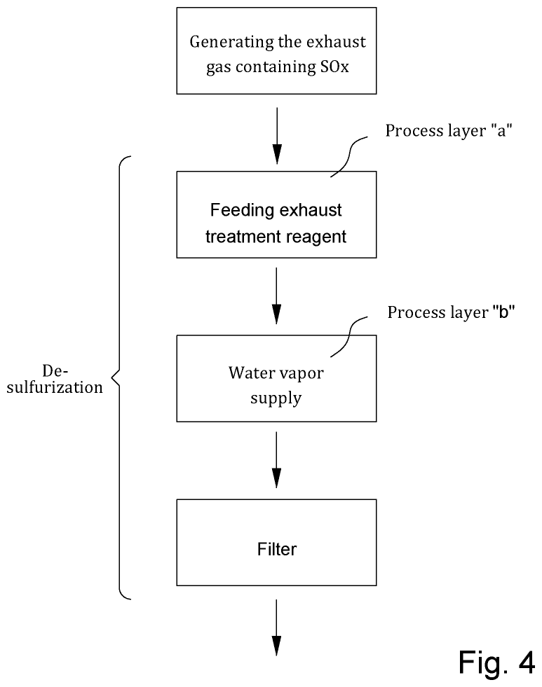

FIG. 4 schematic method sequence of the individual stages or method steps of the method according to the invention for the treatment of sulfur oxides (SOₓ)-containing exhaust gases according to a special embodiment of the present invention and

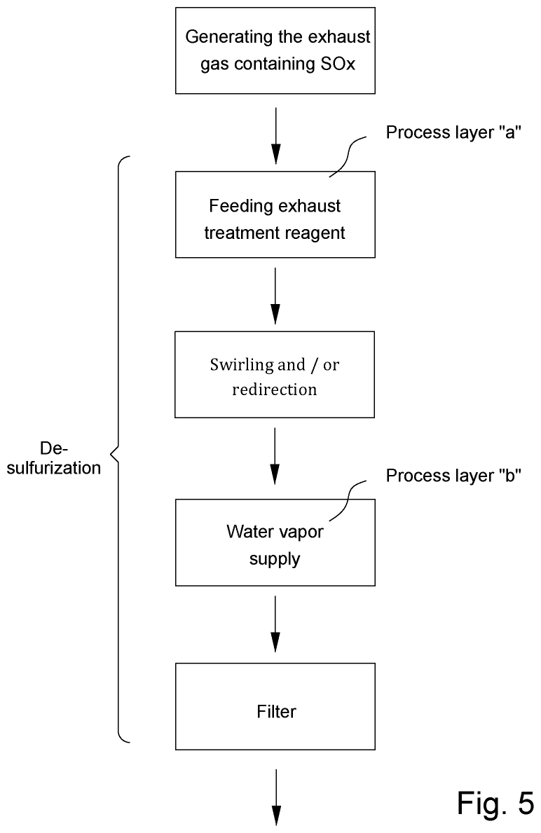

FIG. 5 schematic method sequence of the individual stages or method steps of the method according to the invention for the treatment of sulfur oxides (SOₓ)-containing exhaust gases according to a special embodiment of the present invention.

FIG. 1 shows a system 6 according to the invention for the treatment of sulfur oxides (SOₓ)-containing exhaust gases arising from technical processes for the purpose of removing and/or separating off the sulfur oxides and/or for the purpose of reducing the sulfur oxide content. System 6 comprises a device 7 for carrying out a technical process generating sulfur oxides-containing exhaust gases. The technical process may, for example, be a smelting process or be carried out as part of a smelting operation and/or include combustion. An exhaust gas treatment device 8 is assigned to the device 7, wherein the exhaust gases containing sulfur oxides produced in the device 7 are fed to the exhaust gas treatment device 8. In the example shown, the exhaust gas treatment device 8 is connected downstream and is provided downstream from device 7 in the direction of the method. In other embodiments, the exhaust gas treatment device 8 may also be associated with device 7.

The exhaust gas treatment device comprises a channel-shaped exhaust gas treatment chamber 9 according to FIG. 2. The exhaust gas treatment chamber 9 is subdivided into a first section 10 and a second section 11 which is connected downstream from the first section 10 and/or arranged downstream from the first section 10 in the direction of the method. Furthermore, the exhaust gas treatment device 8 in the first section 10 of the exhaust gas treatment chamber 9 comprises a first injection and/or spraying device 1 for bringing into contact and/or for supplying, especially injecting and/or spraying, an exhaust gas treatment reagent with the sulfur oxides-containing exhaust gases. The first injection and/or spraying device 1 is configured such that an exhaust gas containing the exhaust gas treatment reagent is obtained, which is not shown in the examples shown.

Furthermore, a second injection and/or spraying device 2 is arranged in the second section 11 of the exhaust gas treatment chamber 9 and downstream and downstream from the first injection and/or spraying device 1 in the method direction. The second injection and/or spraying device 2 is provided for contacting and supplying water vapor with the exhaust gas stream containing the exhaust gas treatment reagent. The supply of water vapor can be carried out such that the exhaust gas treatment reagent is reacted with the sulfur oxides contained in the exhaust gases.

In the examples shown it is shown that more than one first injection and/or spraying device 1 and one second injection and/or spraying device 2 may be provided or that the respective injection and/or spraying devices 1, 2 comprise a multitude of lances 12, 13.

It can also be seen from FIG. 2 that the first injection and/or spraying device 1 comprises two first lances 11 and the second injection and/or spraying device 2 comprises two second lances 13.

It is not shown that the second lance 13 can comprise a multitude of openings. For example, the second lance 13 may comprise two to eight openings for the discharge and/or release of the water vapor.

It can be seen from FIG. 2 that the first injection and/or spraying device 1, in the example shown also the first lance 12, is arranged at an angle β of at least essentially 10° to the direction of the exhaust gas stream. The direction of the exhaust gas stream is determined by the direction of flow and thus also the main flow direction or main flow direction of the exhaust gas stream. In other examples, the angle β can vary in a range of from −30° to 30°. A negative angle indicates that the lance 12 is facing downwards instead of upwards, so that an angle β of −20° ultimately also indicates an angle of 340° in analogy to the positive angle β to the main flow direction or main flow direction of the exhaust gas stream.

Furthermore, FIG. 2 shows that two first lances 12 can each be arranged at an angle β of at least substantially 10° to the direction of flow, wherein the two first lances 12 are opposite each other and enclose an angle of at least essentially 160° with each other.

In addition, it can be seen from FIG. 2 that the second injection and/or spraying device 2, in the example shown also the two second lances 13 in each case, are arranged such that the water vapor is supplied at an angle α of at least 20°, in the example shown at an angle α of at least essentially 90°, in relation to the direction of the exhaust gas stream. In the example shown, the direction of the exhaust gas stream indicates the main flow direction or the main flow direction of the exhaust gas stream. In other examples the angle α can be provided in the range of from 20° to 160°. Furthermore, two second lances 13 are each arranged at an angle α of 90° to the direction of flow of the exhaust gas stream, wherein the two second lances 13 form an angle of at least substantially 180° with each other.

The exhaust gas treatment reagent may be introduced centrally into the first section 10 and/or at the edges into the exhaust gas treatment chamber 9 and/or in the first section 10 via the first injection and/or spraying device 1.

In addition, FIG. 1 shows that a turbulence section 4 is arranged between the first section 10 and the second section 11 of the exhaust gas treatment chamber 9 of the exhaust gas treatment device 8. The turbulence section 4 is configured to swirl and/or deflect the exhaust gas stream. By swirling the exhaust gas stream, for example, a good mixing of the exhaust gas stream with the particles of the exhaust gas treatment reagent can be caused.

FIGS. 2 and 3 show that instead of an turbulence section 4 between the first section 10 and the second section 11 a displacer body 3 can be arranged. In the example shown, the displacer body 3 is configured as a perforated diaphragm. The perforated diaphragm can be configured such that for the second injection and/or spraying device 2 it comprises an area for the outlet and/or discharge of the water vapor which is at least essentially free of the particles of the exhaust gas treatment reagent. Furthermore, the second lances 13 of the second injection and/or spraying device 2 are arranged in a region at least essentially free from the particles of the exhaust gas treatment reagent of the exhaust gas stream, so that caking or agglomerations on the second lance 13 can be avoided.

In addition, FIGS. 1 and 3 show that a filter device 5 can be arranged downstream from the second section 11 and the second injection and/or sprayer 2. In the illustrated example the filter device 5 is configured as fabric filter. In this case the exhaust gas flows through the filter device 5 after the second section 11. The filter device 5 is also configured such that dust-like particles can be separated on it. In the method, the solids and/or pollutants contained in the exhaust gases, especially solid and/or dusty particles, preferably of unreacted exhaust gas treatment reagent and/or reaction products of the reacted exhaust gas treatment reagent, can be separated.

In addition, it can be seen from FIG. 3 that a first reservoir device 14 is associated with the first injection and/or spraying device 1, so that the exhaust gas treatment reagent can be supplied to the first injection and/or spraying device 1 via the first reservoir device 14.

Apart from that FIG. 3 shows that the second injection and/or spraying device 2 can be associated with a second reservoir device 15. In the example shown, a heating device 16 is connected downstream from the second reservoir device 15. The heating device 16 is configured for heating water which can be fed to it via the second reservoir device 15. The water vapor generated in this way, saturated steam in other examples, can then be fed to the second injection and/or spraying device 2, especially to the second lances 13.

In the case of a further examples not shown, it is intended that the water vapor is made available to the second injection and/or spraying device 2, especially the second lances 13, from the device 7 and/or from vapor-bearing and/or vapor-generating components or system components of plant 6.

For further details on the system 6 according to the invention, reference may be made to the above general remarks on the system 6 for the treatment of sulfur oxides (SOₓ)-containing exhaust gases from technical processes according to the present invention.

In the process flow diagram shown in FIG. 4 for the treatment of sulfur oxides (SOₓ)-containing exhaust gases from technical processes for the purpose of removing and/or separating off the sulfur oxides and/or reducing the sulfur oxide content, the successive method stages or method steps are shown schematically, the steps of generating the exhaust gas containing SOₓ and the supply to the filter device 5 or the filter being optional.

According to FIG. 5, between the non-optional method steps (a) and (b) the optional method step of swirling and/or deflection is also provided.

In method step (a) the exhaust gas treatment reagent is added. In method step (b), in turn, which is downstream from method step (a), water vapor, preferably saturated steam, is supplied. The exhaust gas treatment method ultimately serves for desulfurization and thus for reducing the proportion of sulfur oxides in the exhaust gases.

For further details on the method sequence according to the invention for the treatment of sulfur oxides (SOₓ)-containing exhaust gases from technical processes, reference can be made to the above general explanations on the exhaust gas treatment method according to the invention.

Further embodiments, modifications and variations of the present invention are easily recognizable and realizable by a person skilled in the art when reading the description, without leaving the scope of the present invention.

The present invention is illustrated by the following examples of implementation, which are not intended to limit the present invention in any way, but only to formulate and explain the exemplary and non-limiting method of implementation.

### EXECUTION EXAMPLES

General Instructions for Implementation (According to the Invention)

The following examples (example series 1 and 2 as well as 2A) show the exhaust gas treatment method according to the invention and the associated separation of sulfur oxides (SOₓ) from exhaust gases originating from technical processes. In a first method step (a), the exhaust gas treatment reagent is added to the exhaust gas. The exhaust gas is then passed through an orifice plate which acts as a displacer. This is followed by an addition of water vapor. For comparison, the invention's inappropriate dry sorption without addition of steam or with upstream addition of steam (i.e. addition of steam before addition of the exhaust gas treatment reagent) was also carried out in the tests to illustrate the improved performance of the exhaust gas treatment method according to the invention.

The water vapor has a pressure of at least essentially 4 bar at a temperature of at least substantially 143° C. The exhaust gas treatment reagent is introduced into the exhaust gas stream by means of a conveying air stream in method step (a).

The procedure of the exhaust gas treatment method according to FIG. 5 is carried out. The exhaust gas treatment device according to the invention is shown in FIG. 3.

The sulfur oxides or the proportion of sulfur oxides in exhaust gas shall be indicated in the tests carried out by measuring sulfur dioxide. SO₃ is also included in the measurement, so that the measurement method works as a summation method in the sense of the definition “sulfur oxides=SO₂+SO₃” (to be indicated as “SO₂”).

### Example Series 1

Within the framework of a first series of examples, exhaust gases originating from a copper smelter with a temperature of at least essentially 40° C. and a water vapor content of 5% by volume were fed into an exhaust gas treatment system.

The added exhaust gas treatment reagent contains at least essentially 75% by weight hydrated lime (slaked lime). In addition, the exhaust gas treatment reagent has grain sizes of at least substantially 35 μm, which have been determined by means of a sieve analysis in accordance with DIN 66165. The average grain size D50 is at least essentially 10 to 15 μm and was also determined by a sieve analysis in accordance with DIN 66165.

The exhaust gas treatment reagent further has a BET surface area of at least essentially 35 m²/g, the BET surface area referring to the sulfur oxide-reactive surface of the exhaust gas treatment reagent, especially of the hydrated lime.

The total pore volume of the exhaust gas treatment reagent shall also be at least substantially 0.35 cm³/g.

The stoichiometric ratios of the addition of the exhaust gas treatment reagent are given in the table below, wherein the stoichiometric ratio is calculated as the ratio of exhaust gas treatment reagent used to reduced and/or separated sulfur oxides. Here, the stoichiometric ratio refers to the exhaust gas treatment reagent to the sulfur oxides.

In the tests carried out, the exhaust gas stream is identical and is in each case about 70,000 standard cubic meters/h, wherein the sulfur oxide loading of the exhaust gas stream before exhaust gas treatment (measured or evaluated as SO₂) is in each case about 700 mg/standard cubic meters of exhaust gas.

Those tests (Nos. 1 and 4) without the addition of water vapor are to be considered as inappropriate procedures.

### Variation of the Addition of Water Vapor and of the Exhaust Gas Treatment Reagent

| | sulfur oxides | | | | | | |
|---|---|---|---|---|---|---|---|
| | (measured in | separated | | | | | |
| | SO2) after | sulfur oxides | separated | | | | stoichiometric |
| | exhaust gas | (measured in | sulfur oxides | | exhaust gas | | ratio of the |
| | treatment in | SO2) in | (measured in | separation | treatment | water | exhaust gas |
| | [mg/standard | [mg/standard | SO2) in | efficiency in | reagent in | vapor in | treatment |
| No. | cubic meters] | cubic meters] | [kg/h] | [%] | [kg/h] | [kg/h] | reagent |
| 1. | 230 | 470 | 32.90 | 67.14 | 380.32 | 0 | 10 |
| 2.* | 150 | 550 | 38.50 | 78.57 | 445.06 | 200 | 10 |
| 3.* | 200 | 500 | 35.00 | 71.43 | 323.68 | 200 | 8 |
| 4. | 150 | 550 | 38.50 | 78.57 | 578.58 | 0 | 13 |
| 5.* | 100 | 600 | 42.00 | 35.71 | 631.18 | 380 | 13 |
| 6.* | 120 | 580 | 40.60 | 82.86 | 469.34 | 380 | 10 |

*inventive

Results:

Consequently, the separation efficiency of the sulfur oxides can be significantly increased by the inventive addition of water vapor for the same stoichiometric ratio of the exhaust gas treatment reagent. Even when the stoichiometric ratio is lowered, the separation efficiency can be increased by the addition of water vapor, wherein the addition of the exhaust gas treatment reagent correlates with the separation efficiency at least in certain areas.

By the inventive lowering the stoichiometric ratio of the exhaust gas treatment reagent to the sulfur oxides, a significantly lower consumption of exhaust gas treatment reagent can be guaranteed and thus the operating costs can be significantly reduced.

Furthermore, the separation efficiency has also been significantly improved.

The exhaust gas treatment method according to the invention shows very good results both in terms of separation efficiency and reduction of the stoichiometric ratio.

In the tests carried out, it could also be shown that at least essentially no caking or agglomerations occurs at the second injection and/or spraying device and therefore also not at the second lance, so that clogging of the second lance can be reliably prevented.

### Example Series 2

In example series 2, exhaust gases from zinc smelters are treated, wherein the exhaust gases have an exhaust gas temperature of 60° C. and a water vapor content of at least essentially 3% by volume. The exhaust gases in example series 2 have a higher proportion of sulfur oxides than the exhaust gases from example series 1.

The exhaust gas treatment reagent used in example series 2 has at least essentially 93% by weight (degree of purity) of hydrated lime and furthermore a grain size of at least essentially 30 μm, which has been determined by means of a sieve analysis in accordance with DIN 66165. The average grain size D50 of the hydrated lime is in the range of 5 to 8 μm (determined by sieve analysis in accordance with DIN 66165).

The BET surface area is between 40 and 60 m²/g.

Besides, the total pore volume is between 0.2 and 0.4 cm³/g.

The exhaust gas treatment reagent has also been finely ground and sifted and also dry quenched and freed from any coarse grain fractions present.

In the tests carried out, the exhaust gas stream is identical and is in each case about 70,000 standard cubic meters/h, wherein the sulfur oxide loading of the exhaust gas stream before exhaust gas treatment (measured or evaluated as SO₂) is in each case about 1000 mg/standard cubic meters of exhaust gas.

### Variation of the Addition of Water Vapor and of the Exhaust Gas Treatment Reagent

| | sulfur oxides | | | | | | |
|---|---|---|---|---|---|---|---|
| | (measured in | separated | | | | | |
| | SO2) after | sulfur oxides | separated | | | | stoichiometric |
| | exhaust gas | (measured in | sulfur oxides | | exhaust gas | | ratio of the |
| | treatment in | SO2) in | (measured in | separation | treatment | water | exhaust gas |
| | [mg/standard | [mg/standard | SO2) in | efficiency in | reagent in | vapor in | treatment |
| No. | cubic meters] | cubic meters] | [kg/h] | [%] | [kg/h] | [kg/h] | reagent |
| 1. | 560 | 440 | 30.80 | 44 | 391.65 | 0 | 11 |
| 2.* | 100 | 900 | 63.00 | 90 | 801.11 | 300 | 11 |
| 3.* | 150 | 850 | 59.50 | 85 | 550.26 | 300 | 8 |
| 4. | 580 | 420 | 29.40 | 42 | 441.82 | 0 | 13 |
| 5.* | 60 | 940 | 65.80 | 94 | 988.84 | 370 | 13 |
| 6.* | 100 | 900 | 63.00 | 90 | 655.45 | 370 | 9 |

*inventive

Results:

The above table illustrates the results according to the invention in terms of separation efficiency and reduction of the stoichiometric ratio of the exhaust gas treatment reagent to the sulfur oxides. The addition of water vapor according to the invention can both improve the separation efficiency and reduce the stoichiometric ratio with improved separation efficiency. Analogous to example series 1, it could be proven in the tests carried out that caking and/or agglomerations on the system and especially on the second injection and/or spraying device, especially on the second lances, can be reliably prevented. A clogging of the second lances is not to be feared with the method according to the invention. Operating costs can be saved by lowering the stoichiometric ratio of the exhaust gas treatment reagent. If the stoichiometric ratio is not necessarily lowered, the separation efficiency can ultimately be significantly improved.

### Example Series 2A

In example series 2A, test 1 of example series 2 (not according to invention) and test 2 of example series 2 (according to invention) are repeated, but with the deviation that the amount of exhaust gas treatment reagent used in both tests was identical at 405 kg/h.

In the case of non-invention test 1 of example series 2A, the separation efficiency for the sulfur oxides was only 45%, whereas in the case of inventive test 2 of example series 2A, the separation efficiency for the sulfur oxides was 73%.

The separation efficiency can be significantly improved by the addition of water vapor after the addition of the exhaust gas treatment reagent, in accordance with the invention.

In a further experiment 3 of example series 2A (not in accordance with the invention), experiment 2 of example series 2A was repeated, but with the deviation that the addition of the water vapor takes place before the addition of the exhaust gas treatment reagent. In this case, the separation efficiency for the sulfur oxides is initially only 53% within the first hour, wherein, due to caking on the system components in the exhaust gas treatment chamber, especially in the second section of the exhaust gas treatment chamber, the separation efficiency for this method, which is not in accordance with the invention, was already below 40% after 3 h. This shows that the method according to the invention (i.e. addition of the water vapor only after addition of the exhaust gas treatment reagent) not only provides an improved initial separation efficiency, but also enables trouble-free continuous operation with constantly good separation efficiency.

### Example Series 3 (not According to Invention)

In example series 3, the six experiments of example series 2 were repeated, but with the deviation that the addition of the water vapor does not take place after addition of the exhaust gas treatment reagent but before it and/or upstream in the method direction. Accordingly, in method step (a) the water vapor is first introduced into the exhaust gas stream in the first section of the exhaust gas treatment chamber, especially injected and/or sprayed, and then in method step (b) the exhaust gas treatment reagent is introduced in the second section of the exhaust gas treatment chamber, especially injected and/or sprayed.

After 1 to 2 hours of operation, first signs of caking on the system components in the exhaust gas treatment chamber, especially in the second section of the exhaust gas treatment chamber, were observed. After one day, the second injection and/or spraying device for the water vapor had been clogged or caked, wherein the outlet or discharge of the water vapor was strongly impaired by the caking.

A shutdown of the plant due to a failed exhaust gas treatment system occurred after 2 to 3 days of operation. The shutdown was caused by caking of the second injection and/or spraying device, especially the water vapor lance.

During operation of the system and the exhaust gas treatment device, the separation efficiency of the method according to the invention could not be achieved. At the beginning of the operation of the exhaust gas treatment device, a sufficiently good separation efficiency of sulfur oxides was still ensured. After a few hours, however, the separation efficiency dropped significantly, especially due to the reduced water vapor supply, wherein the separation efficiency after 2 to 3 hours only reached sufficient results. After one day the separation efficiency of sulfur oxides was unacceptable. The separation efficiency of example series 3 was subject to the results of the method according to the invention in each of the six tests both at the beginning of operation and after several hours of operation.

### LIST OF REFERENCE CHARACTERS

1 first injection and/or spraying device
2 second injection and/or spraying device
3 displacement body
4 turbulence section
5 filter device
6 system (installment, plant)
7 device
8 exhaust gas treatment device
9 exhaust gas treatment chamber
10 first section
11 second section
12 first lance
13 second lance
14 first reservoir device
15 second reservoir device
16 heating device
α angle
β angle

1-15. (canceled)

16. A method for the purification of sulfur oxides-containing exhaust gases arising from technical processes, wherein the method comprises the step of removing the sulfur oxides for the purpose of reducing the sulfur oxide content in the exhaust gases,
wherein the sulfur oxides-containing exhaust gases are subjected to an exhaust gas treatment by desulfurization by means of at least one particulate sulfur oxide-reactive exhaust gas treatment reagent,
wherein:
(a) first, in a method step (a), the sulfur oxides-containing exhaust gases are brought into contact with the exhaust gas treatment reagent such that an exhaust gas stream containing the exhaust gas treatment reagent is obtained, wherein the exhaust gas treatment reagent is injected into the exhaust gases in fine dispersion by means of at least one first lance-shaped injection device, and
(b) subsequently, in a method step (b), the exhaust gas stream containing the exhaust gas treatment reagent is brought into contact with water vapor such that the exhaust gas treatment reagent is reacted with the sulfur oxides contained in the exhaust gases, wherein the water vapor is injected into the exhaust gases in fine dispersion by means of at least one second lance-shaped injection device, wherein the second lance-shaped injection device is kept free from the exhaust gas treatment reagent by means of at least one displacement body,
wherein, subsequently to method step (b), the amount of water vapor in the exhaust gases is reduced.

17. The method according to claim 16,
wherein the exhaust gas treatment method is a dry sorption method; and
wherein the exhaust gas treatment reagent is used as a solid or a mixture of solids in the form of a preferably fine powder.

18. The method according to claim 16,
wherein the exhaust gas treatment reagent contains or consists of at least one sulfur oxide-reactive reagent selected from the group consisting of alkali metal and alkaline earth metal hydroxides, -oxides, -carbonates and -hydrogen carbonates as well as mixtures and combinations thereof.

19. The method according to claim 16,
wherein the exhaust gas treatment reagent is at least one of a hydrated lime and a hydrated lime containing reagent with at least 50% by weight hydrated lime, based on the hydrated lime containing reagent.

20. The method according to claim 16,
wherein the exhaust gas treatment reagent has average grain sizes D50 in the range of from 1 to 50 μm, determined by sieve analysis; and
wherein the exhaust gas treatment reagent has a BET-surface in the range of from 5 to 100 m²/g; and
wherein the exhaust gas treatment reagent has a total pore volume in the range of from 0.01 to 0.95 cm³/g.

21. The method according to claim 16,
wherein, in method step (b), the amount of water vapor is increased in the exhaust gas stream containing the exhaust gas treatment reagent such that condensation of water takes place on the exhaust gas treatment reagent.

22. The method according to claim 16,
wherein, in method step (b), the amount of water vapor in the exhaust gas stream containing the exhaust gas treatment reagent is increased such that the water vapor content in the exhaust gas treatment reagent containing exhaust gas stream is increased by 0.1 to 20% by volume.

23. The method according to claim 16,
wherein, in method step (b), the amount of water vapor in the exhaust gas stream containing the exhaust gas treatment reagent is increased such that the water vapor content of the resulting exhaust gas stream containing the exhaust gas treatment reagent and brought into contact with water vapor is in the range of from 2 to 25% by volume; and
wherein, in method step (b), water vapor is supplied in an amount in the range of from 5 to 250 kg/h, based on 10,000 standard cubic meters/h exhaust gases; and
wherein, in method step (b), the water vapor is supplied with a temperature in the range of from 110° C. to 185° C.

24. The method according to claim 16,
wherein, in method step (b), the water vapor is supplied with a velocity in the range of from 50 m/s to 500 m/s.

25. The method according to claim 16,
wherein, in method step (b), the water vapor is supplied to the exhaust gas stream with a velocity which is at least twice as high as the velocity of the exhaust gas stream.

26. The method according to claim 16,
wherein, in the method step (b), the water vapor is supplied with an angle α in the range of from 20° to 160°, relative to the direction of the exhaust gas stream.

27. The method according to claim 16,
wherein, subsequently to method step (b), the amount of water vapor in the exhaust gas stream is reduced such that the water vapor content of the exhaust gas stream is in the range of from 1 to 24% by volume.

28. A method for the purification of sulfur oxides-containing exhaust gases arising from technical processes, wherein the method comprises the step of removing the sulfur oxides for the purpose of reducing the sulfur oxide content in the exhaust gases,
wherein the sulfur oxides-containing exhaust gases are subjected to an exhaust gas treatment by desulfurization by means of at least one particulate sulfur oxide-reactive exhaust gas treatment reagent;
wherein:
(a) first, in a method step (a), the sulfur oxides-containing exhaust gases are brought into contact with the exhaust gas treatment reagent such that an exhaust gas stream containing the exhaust gas treatment reagent is obtained,
wherein the exhaust gas treatment reagent is injected into the exhaust gases in fine dispersion by means of at least one first lance-shaped injection device,
wherein the exhaust gas treatment reagent is at least one of a hydrated lime and a hydrated lime containing reagent with at least 50% by weight hydrated lime, based on the hydrated lime containing reagent and
wherein the exhaust gas treatment reagent has average grain sizes D50 in the range of from 1 to 50 μm, determined by sieve analysis; and
(b) subsequently, in a method step (b), the exhaust gas stream containing the exhaust gas treatment reagent is brought into contact with water vapor such that the exhaust gas treatment reagent is reacted with the sulfur oxides contained in the exhaust gases,
wherein the water vapor is injected into the exhaust gases in fine dispersion by means of at least one second lance-shaped injection device,
wherein the amount of water vapor in the exhaust gas stream containing the exhaust gas treatment reagent is increased by 0.1 to 20% by volume,
wherein the water vapor is supplied to the exhaust gas stream with a velocity which is at least twice as high as the velocity of the exhaust gas stream, and
wherein the second lance-shaped injection device is kept free from the exhaust gas treatment reagent by means of at least one displacement body;
wherein, subsequently to method step (b), the amount of water vapor in the exhaust gases is reduced.

29. A system for the purification of sulfur oxides-containing exhaust gases arising from technical processes for the purpose of removing the sulfur oxides,
wherein the system comprises an exhaust gas generating device for carrying out a technical process generating sulfur oxides-containing exhaust gases and
wherein the system further comprises an exhaust gas treatment device for the exhaust gas treatment of the sulfur oxide-containing exhaust gases generated in the exhaust gas generating device, which exhaust gas treatment device is arranged downstream from the exhaust gas generating device,
wherein the exhaust gas treatment device comprises an exhaust gas treatment chamber,
wherein the exhaust gas treatment chamber comprises at least one first section and, downstream from the first section, a second section, wherein the exhaust gas treatment device further comprises:
(A) arranged in the first section of the exhaust gas treatment chamber, at least one first lance-shaped injection device for injecting an exhaust gas treatment reagent in fine dispersion into the sulfur oxides-containing exhaust gases, wherein the first injection device is configured such that an exhaust gas stream containing the exhaust gas treatment reagent is obtained, and,
(B) arranged in the second section of the exhaust gas treatment chamber and arranged downstream from the first injection device, at least one second lance-shaped injection device for injecting, via discharge openings, water vapor into the exhaust gas stream containing the exhaust gas treatment reagent, wherein the second injection device is configured such that the exhaust gas treatment reagent is reacted with the sulfur oxides contained in the exhaust gases,
wherein at least one displacement body is arranged between the first section of the exhaust gas treatment chamber and the second section of the exhaust gas treatment chamber, wherein the displacement body is configured to generate an area being at least essentially free of exhaust gas treatment reagent for supplying the water vapor in the area of the water vapor discharge openings of the second injection device.

30. The system according to claim 29,
wherein the exhaust gas treatment device is configured such that the sulfur oxides-containing exhaust gases are subjected to an exhaust gas treatment via desulfurization by means of at least one particulate sulfur oxide-reactive exhaust gas treatment reagent; and
wherein the first injection device comprises from two to eight first lances for introducing the exhaust gas treatment reagent into the sulfur oxides-containing exhaust gases; and
wherein the second injection device comprises from two to eight second lances for introducing water vapor into the exhaust gases; and
wherein the second lance comprises a multitude of discharge openings for releasing the water vapor.

31. The system according to claim 29,
wherein the first injection device is configured and arranged such that the exhaust gas treatment reagent is supplied to the first section of the exhaust gas treatment chamber in an angle β in the range of from −30° to 30°, relative to the direction of the exhaust gas stream; and
wherein the second injection device is configured and arranged such that the water vapor is supplied to the second section of the exhaust gas treatment chamber in an angle α in the range of from 20° to 160°, relative to the direction of the exhaust gas stream.

32. The system according to claim 29,
wherein a filter device is arranged downstream from the second section of the exhaust gas treatment chamber, wherein the filter device is configured to filter the exhaust gases for separating off solids and harmful substances contained in the exhaust gases.

33. The system according to claim 29,
wherein the system further comprises a first reservoir device for the storage of the exhaust gas treatment reagent for supplying the exhaust gas treatment reagent to the first injection device, wherein the first reservoir device is connected with the first injection device; and
wherein the system further comprises a second reservoir device for the storage of at least one of water and water vapor for supplying at least one of water and water vapor to the second injection device, wherein the second reservoir device is connected with the second injection device.
